(19) United States
(12) Patent Application Publication
(10) Pub. No.: US 2018/0097575 A1
(43) Pub. Date: Apr. 5, 2018

(54) TERMINAL APPARATUS, BASE STATION APPARATUS, AND COMMUNICATION METHOD

(71) Applicant: SHARP KABUSHIKI KAISHA, Sakai City, Osaka (JP)

(72) Inventors: HIROMICHI TOMEBA, Sakai City (JP); RYOTA YAMADA, Sakai City (JP); KATSUYA KATO, Sakai City (JP); JUNGO GOTO, Sakai City (JP); OSAMU NAKAMURA, Sakai City (JP); TOMOKI YOSHIMURA, Sakai City (JP); YASUHIRO HAMAGUCHI, Sakai City (JP)

(21) Appl. No.: 15/553,182

(22) PCT Filed: Feb. 24, 2016
(86) PCT No.: PCT/JP2016/055354

§ 371 Date: Aug. 24, 2017

(30) Foreign Application Priority Data
Feb. 26, 2015 (JP) 2015-036029

(51) Int. Cl. H04J 11/00; H04W 28/04; H04W 72/04; H04W 72/12; H04J 13/00

(52) U.S. Cl. CPC H04J 11/003; H04W 28/04; H04J 13/0007; H04W 72/04; H04W 72/12; H04J 11/0086

(57) ABSTRACT

Provided are a base station apparatus, a terminal apparatus, and a communication method, in all of which interference is reduced to improve throughput and to increase more opportunity for communication by each terminal apparatus. A terminal apparatus according to the present invention is provided with a function of receiving information relating to a multiplexed state of and information relating to a retransmission state of a transmit signal that is transmitted to the terminal apparatus itself; a function of receiving a non-orthogonal multiplexing signal that results from a base station apparatus non-orthogonally multiplexing at least some of the transmit signal that is transmitted to the terminal apparatus itself and a transmit signal that is transmitted to another terminal apparatus, for transmission, using the same radio resource; and a function of performing demodulation processing based on the information relating to the multiplexed state of the transmit signal that is transmitted to the terminal apparatus itself, and the information relating to the retransmission state of the transmit signal that is transmitted to the terminal apparatus itself.

### TECHNICAL FIELD

The present invention relates to a terminal apparatus, a base station apparatus, and a communication method.

### BACKGROUND ART

In communication systems such as Long Term Evolution (LTE) and LTE-Advanced (LTE-A) which have been developed by Third Generation Partnership Project (3GPP), a cellular constitution is employed in which a plurality of areas, each of which is covered by a base station apparatus (a base station, a transmission station, a transmission point, a downlink transmission apparatus, an uplink reception apparatus, a transmit antenna group, a transmit antenna port group, a component carrier, or an eNodeB), or by a transmission station that is equivalent to the base station apparatus, are arranged in cells, and thus a communication area can be enlarged. In such cellular constitution, if the same frequency is used between neighboring cells or sectors, frequency efficiency can be improved.

In recent years, techniques with which a plurality of terminal apparatuses are non-orthogonally multiplexed for transmission by allocating the same time, frequency, and spatial resource have been studied in order to increase a system capacity or create more opportunity for communication. Because the base station apparatus performs transmission while a plurality of terminal apparatuses are non-orthogonally multiplexed, interference between users occurs. Therefore, it is desirable that the terminal apparatus cancels inter-user interference. Codeword Level Interference Cancellation (CWIC) in which interference is removed after an interference signal is decoded is an example of the technique with which the inter-user interference is canceled. Such techniques are described in NPL 1.

### CITATION LIST

### Non Patent Literature

NPL 1: “Enhanced Multiuser Transmission and Network Assisted Interference Cancellation”, 3GPP TSG RAN Meeting #66, December 2014

### SUMMARY OF INVENTION

### Technical Problem

In order that a terminal apparatus, that is, a reception apparatus correctly demodulate a desired signal from a signal that is transmitted by a base station apparatus in a state of being non-orthogonally multiplexed, it is desirable that the terminal apparatus correctly cancels a signal that is transmitted to another terminal apparatus.

However, when viewed from the terminal apparatus, the signal that is non-orthogonally multiplexed is a signal in a state of a plurality of modulation signals being multiplexed. Because of this, in terms of an actual modulation signal point that is used for a signal which is transmitted to each terminal apparatus, signal points are extremely close to each other, and it is difficult to correctly modulate each of the signals.

An object of the present invention, which was made in view of such situation, is to provide a base station apparatus, a terminal apparatus, and a communication method, in all of which a reduction in interference makes it possible to improve throughput and to increase opportunity for communication by each terminal apparatus.

### Solution to Problem

In order to deal with the problem described above, the following constitutions of a base station apparatus, a terminal apparatus and a communication method according to the present invention are provided.

(1) That is, a terminal apparatus according to the present invention is a terminal apparatus that communicates with a base station apparatus and includes: a reception unit provided with a function of receiving information relating to a multiplexed state of a transmit signal that is transmitted to the terminal apparatus itself and information relating to a retransmission state of the transmit signal that is transmitted to the terminal apparatus itself and a function of receiving a non-orthogonal multiplexing signal that results from the base station apparatus non-orthogonally multiplexing at least some of the transmit signal that is transmitted to the terminal apparatus itself and a transmit signal that is transmitted to another terminal apparatus, for transmission, using the same radio resource; and a demodulation unit that performs demodulation processing based on the information relating to the multiplexed state of the transmit signal that is transmitted to the terminal apparatus itself and the information relating to the retransmission state of the transmit signal that is transmitted to the terminal apparatus itself.

(2) Furthermore, in the terminal apparatus according to (1) described above, the information relating to the multiplexed state of a transmit signal is a transmission mode, and the demodulation unit performs the demodulation processing based on the information relating to the retransmission state of the transmit signal that is transmitted to the terminal apparatus itself, in a case where the transmission mode is a predetermined transmission mode.

(3) Furthermore, in the terminal apparatus according to (2) described above, the predetermined transmission mode is a transmission mode capable of receiving the non-orthogonal multiplexing signal.

(4) Furthermore, in the terminal apparatus according to (3) described above, the demodulation unit performs interference suppression on the non-orthogonal multiplexing signal, only when the transmission mode configuration mode indicates the transmission mode capable of receiving the non-orthogonal multiplexing signal and the information relating to the retransmission state of the transmit signal that is transmitted to the terminal apparatus itself indicates that the transmit signal that is transmitted to the terminal apparatus itself is an initial signal.

(5) Furthermore, in the terminal apparatus according to (1) described above, the information relating to the multiplexed state of the transmit signal that is transmitted to the terminal apparatus itself is information indicating a labeling method that is used, by the base station apparatus, for the transmit signal that is transmitted to the terminal apparatus itself, and the demodulation unit switches between performing and not performing interference suppression on the non-orthogonal multiplexing signal, based on the information relating to the retransmission state of the transmit signal that is transmitted to the terminal apparatus itself, in a case where the information indicating the labeling method indicates a predetermined labeling method.

(6) Furthermore, in the terminal apparatus according to (1) described above, the base station apparatus is able to use a plurality of labeling methods selectively for the transmit signal that is transmitted to the terminal apparatus itself, and the demodulation unit acquires a labeling method that is performed on the transmit signal, based on the information relating to the multiplexed state of the transmit signal that is transmitted to the terminal apparatus itself.

(7) Furthermore, in the terminal apparatus according to any one of (1) to (6) described above, the information relating to the retransmission state of the transmit signal that is transmitted to the terminal apparatus itself is a new data indicator (NDI), and the demodulation unit performs the demodulation processing on the transmit signal that is transmitted to the terminal apparatus itself, regarding the transmit signal that is transmitted to the other terminal apparatus as not being non-orthogonally multiplexed by the base station apparatus, in a case where the NDI indicates that the transmit signal that is transmitted to the terminal apparatus itself is a retransmit signal.

(8) Furthermore, in the terminal apparatus according to any one of (1) to (6) described above, the information relating to the retransmission state of the transmit signal that is transmitted to the terminal apparatus itself is a redundancy version (RV), and the demodulation unit performs the demodulation processing on the transmit signal that is transmitted to the terminal apparatus itself, regarding the transmit signal that is transmitted to the other terminal apparatus as not being non-orthogonally multiplexed by the base station apparatus, in a case where the RV is a value other than a value indicating that the largest number of systematic bits are included in the transmit signal.

(9) Furthermore, in the terminal apparatus according to any one of (1) to (6), the demodulation unit performs the demodulation processing, using information relating to a transmit power for a retransmit signal, which is notified by the base station apparatus, in a case where the transmit signal that is transmitted to the terminal apparatus itself is the retransmit signal.

(10) A base station apparatus according to the present invention is a base station apparatus that communicates with a plurality of terminal apparatuses and includes: a modulation unit provided with a function of generating a non-orthogonal multiplexing signal that results from non-orthogonally multiplexing at least some of transmit signals that are transmitted to the plurality of terminal apparatuses, using the same radio resource, in which the modulation unit switches between performing and not performing non-orthogonal multiplexing on the transmit signals that are transmitted to the plurality of terminal apparatuses, based on information relating to a multiplexed state of the transmit signals that are transmitted to the plurality of terminal apparatuses and information relating to a retransmission state of the transmit signals that are transmitted to the plurality of terminal apparatuses.

(11) Furthermore, in the base station apparatus according to (10) described above, the information relating to the multiplexed state of a transmit signal is a transmission mode, and the modulation unit switches between performing and not performing the non-orthogonal multiplexing on the transmit signals that are transmitted to the plurality of terminal apparatuses, based on the information relating to the retransmission state of the transmit signals that are transmitted to the plurality of terminal apparatuses, in a case where the transmission mode is a predetermined transmission mode.

(12) Furthermore, in the base station apparatus according to (11) described above, the predetermined transmission mode is a transmission mode capable of transmitting the non-orthogonal multiplexing signal.

(13) Furthermore, in the base station apparatus according to (12), the modulation unit performs the non-orthogonal multiplexing on the transmit signals that are transmitted to the plurality of terminal apparatuses, only when the transmission mode configuration information indicates the transmission mode capable of transmitting the non-orthogonal multiplexing signal and the information relating to the retransmission state of the transmit signals that are transmitted to the plurality of terminal apparatuses indicates that at least one of the transmit signals that are transmitted to the plurality of terminal apparatuses is an initial signal.

(14) Furthermore, in the base station apparatus according to (10), the information relating to the multiplexed state of the transmit signals that are transmitted to the plurality of terminal apparatuses is information indicating a labeling method that is used, by the modulation unit, for the transmit signals that are transmitted to the plurality of terminal apparatuses, and the modulation unit switches between performing and not performing the non-orthogonal multiplexing on the transmit signals that are transmitted to the plurality of terminal apparatuses, based on the information relating to the retransmission state of the transmit signals that are transmitted to the plurality of terminal apparatuses, in a case where the information indicating the labeling method indicates a predetermined labeling method.

(15) Furthermore, in the base station apparatus according to (10), the modulation unit is able to use a plurality of labeling methods selectively for the transmit signal that is transmitted to the terminal apparatus itself, and switches between the plurality of labeling methods, based on the information relating to the retransmission state of the transmit signals that are transmitted to the plurality of terminal apparatuses.

(16) Furthermore, in the base station apparatus according to any one of (10) to (15), the information relating to the retransmission state of the transmit signals that are transmitted to the plurality of terminal apparatuses is a new data indicator (NDI), and the modulation unit does not perform the non-orthogonal multiplexing on the transmit signals that are transmitted to the plurality of terminal apparatuses, in a case where the NDI that is configured for at least one of the transmit signals that are transmitted to the plurality of terminal apparatuses is a value indicating that the transmit signal is a retransmit signal.

(17) Furthermore, in the base station apparatus according to any one of (10) to (15), the information relating to the retransmission state of the transmit signals that are transmitted to the plurality of terminal apparatuses is a redundancy version (RV), and the modulation unit does not perform the non-orthogonal multiplexing on the transmit signals that are transmitted to the plurality of terminal apparatuses, in a case where the RV that is configured for at least one of the transmit signals that are transmitted to the plurality of terminal apparatuses is a value other than a value indicating that the largest number of systematic bits are included.

(18) Furthermore, in the base station apparatus according to any one of (10) to (15), information that is associated with a transmit power for a retransmit signal is notified to a terminal apparatus to which a retransmit signal is transmitted, in a case where the transmit signal on which the modulation unit performs the non-orthogonal multiplexing is the retransmit signal.

(19) Furthermore, a communication method according to the present invention is a communication method for use in a terminal apparatus that communicates with a base station apparatus, the method including: a step of receiving information relating to a multiplexed state of a transmit signal that is transmitted to the terminal apparatus itself and information relating to a retransmission state of the transmit signal that is transmitted to the terminal apparatus itself; a step of receiving a non-orthogonal multiplexing signal that results from the base station apparatus non-orthogonally multiplexing at least some of the transmit signal that is transmitted to the terminal apparatus itself and a transmit signal that is transmitted to another terminal apparatus, for transmission, using the same radio resource; and a step of performing demodulation processing based on the information relating to the multiplexed state of the transmit signal that is transmitted to the terminal apparatus itself and the information relating to the retransmission state of the transmit signal that is transmitted to the terminal apparatus itself.

(20) Furthermore, a communication method according to the present invention is a communication method for use in a base station apparatus that communicates with a plurality of terminal apparatuses, the method including: a step of generating a non-orthogonal multiplexing signal that results from non-orthgonally multiplexing at least some of transmit signals that are transmitted to the plurality of terminal apparatuses, using the same radio resource; and a step of causing the modulation unit to switch between performing and not performing non-orthogonal multiplexing on the transmit signals that are transmitted to the plurality of terminal apparatuses, based on information relating to a multiplexed state of the transmit signals that are transmitted to the plurality of terminal apparatuses and information relating to a retransmission state of the transmit signals that are transmitted to the plurality of terminal apparatuses.

### Advantageous Effects of Invention

According to the present invention, an interference signal can be reduced and throughput can be improved.

### BRIEF DESCRIPTION OF DRAWINGS

FIG. 1 is a diagram illustrating an example of a communication system according to the present invention.

FIG. 2 is a block diagram illustrating an example of a constitution of a base station apparatus according to the present invention.

FIG. 3 is a block diagram illustrating an example of a constitution of a coding unit according to the present invention.

FIG. 4 is a schematic diagram illustrating an example of a coded block according to the present invention.

FIG. 5 is a schematic diagram illustrating an example of a transmit signal according to the present invention.

FIG. 6 is a schematic diagram illustrating an example of the transmit signal according to the present invention.

FIG. 7 is a schematic diagram illustrating an example of the transmit signal according to the present invention.

FIG. 8 is a schematic diagram illustrating an example of a relationship between the transmit signal and a reception signal according to the present invention.

FIG. 9 is a schematic diagram illustrating an example of the transmit signal according to the present invention.

FIG. 10 is a schematic diagram illustrating an example of the transmit signal according to the present invention.

FIG. 11 is a schematic diagram illustrating an example of the relationship between the transmit signal and the reception signal according to the present invention.

FIG. 12 is a block diagram illustrating an example of a constitution of a terminal apparatus according to the present invention.

### DESCRIPTION OF EMBODIMENTS

A communication system according to the present embodiment includes a base station apparatus (a transmission apparatus, a cell, a transmission point, a transmit antenna group, a transmit antenna port group, a component carrier, or an eNodeB) and a terminal apparatus (a terminal, a mobile terminal, a reception point, a reception terminal, a reception apparatus, a receive antenna group, a receive antenna port group or a UE).

According to the present embodiment, “X/Y” includes the meaning of “X or Y”. According to the present embodiment, “X/Y” includes the meaning of “X and Y”. According to the present embodiment, “X/Y” includes the meaning of “X and/or Y”.

### 1.1 First Embodiment

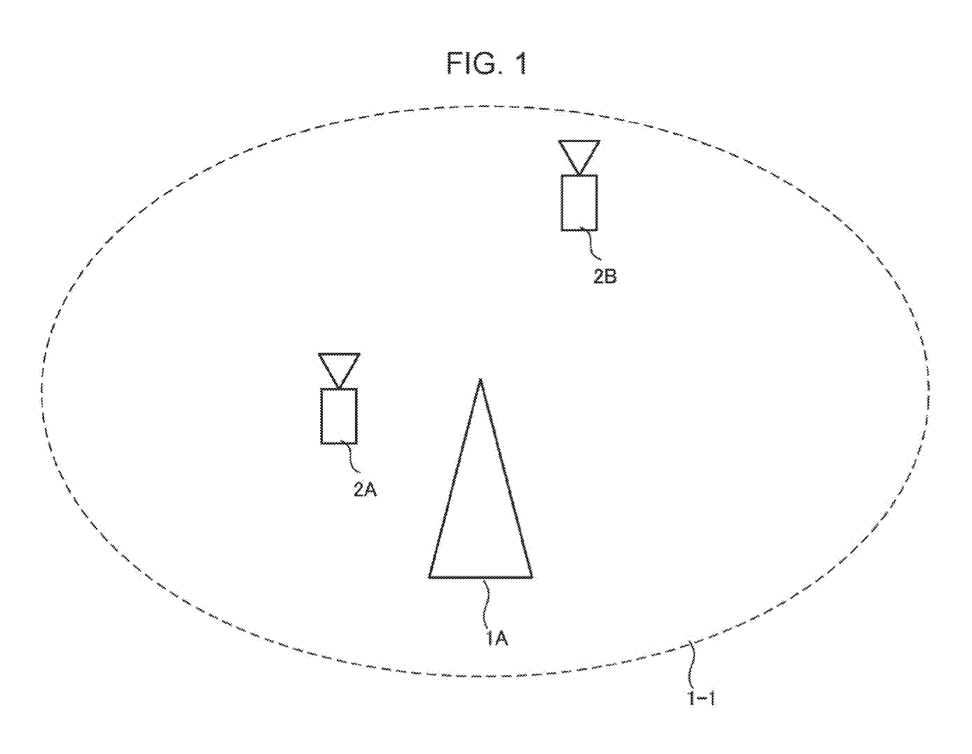

FIG. 1 is a diagram illustrating an example of a communication system according to the present embodiment. As illustrated in FIG. 1, the communication system according to the present embodiment includes a base station apparatus 1A and terminal apparatuses 2A and 2B. Furthermore, coverage 1-1 is a range (a communication area) in which it is possible that the base station apparatus 1A connects to the terminal apparatus. Furthermore, the terminal apparatuses 2A and 2B are collectively also referred to as a terminal apparatus 2.

In FIG. 1, in uplink wireless communication from the terminal apparatus 2A to the base station apparatus 1A, the following uplink physical channels are used. The uplink physical channels are used to transmit information that is output from a higher layer.
Physical Uplink Control Channel (PUCCH)
Physical Uplink Shared Channel (PUSCH)
Physical Random Access Channel (PRACH)

The PUCCH is used to transmit Uplink Control Information (UCI). At this point, the Uplink Control Information includes a positive acknowledgement (ACK) or a negative acknowledgement (NACK) (ACK or NACK) of downlink data (a downlink transport block or a Downlink-Shared Channel (DL-SCH)). The ACK or NACK of the downlink data is also referred to as an HARQ-ACK or HARQ feedback.

Furthermore, the Uplink Control Information includes Channel State Information (CSI) for downlink. Furthermore, the Uplink Control Information includes a Scheduling Request (SR) that is used to make a request for a resource for an Uplink-Shared Channel (UL-SCH). A Rank Indicator (RI) indicating the suitable number of spatial multiplexes, a Precoding Matrix Indicator (PMI) indicating a suitable precoder, a Channel Quality Indicator (CQI) indicating a suitable transmission rate, and the like correspond to the Channel State Information.

The Channel Quality Indicator (CQI) (which is hereinafter referred to as a CQI value) can be assumed to be a suitable modulation scheme (for example, QPSK, 16 QAM, 64 QAM, 256 QAM, or the like) in a predetermined band (which will be described in detail below) and a coding rate. The CQI value can be assumed to be an index (a CQI Index) that is determined with the change scheme and the cord rate. The CQI value can also be assumed to be determined in advance in the system.

It is noted that the Rank Indicator and the Precoding Quality Indicator can be assumed to be determined in advance in the system. The Rank Indicator or the Precoding Matrix Indicator can be assumed to be an index that is determined in advance with the number of spatial multiplexes or the Precoding Matrix information. It is noted that values of the Rank Indicator, the Precoding Matrix Indicator, and the Channel Quality Indicator (CQI) are collectively referred to as a CSI value.

The PUSCH is used to transmit uplink data (an uplink transport block or the UL-SCH). Furthermore, the PUSCH may be used to transmit the ACK or NACK and/or the Channel State Information, along with the uplink data. Furthermore, the PUSCH may be used to transmit only the Uplink Control Information.

Furthermore, the PUSCH is used to transmit an RRC message. The RRC message is information or a signal that is processed in a Radio Resource Control (RRC) layer. Furthermore, the PUSCH is used to transmit a MAC Control Element (CE). At this point, the MAC CE is information or a signal that is processed (transmitted) in a Medium Access Control (MAC) layer.

For example, a power headroom may be included in the MAC CE and may be reported through the PUSCH. That is, a MAC CE field may be used to indicate a power headroom level.

The PRACH is used to transmit a random access preamble.

Furthermore, in the uplink wireless communication, an Uplink Reference Signal (UL RS) is used as an uplink physical signal. The uplink physical signal is not used to transmit the information that is output from the higher layer, but is used by a physical layer. At this point, a Demodulation Reference Signal (DMRS) and a Sounding Reference Signal (SRS) are included in the Uplink Reference Signal.

The DMRS is associated with transmission of the PUSCH or the PUCCH. For example, the base station apparatus 1A uses the DMRS to perform channel reconfiguration of the PUSCH or the PUCCH. The SRS is not associated with the transmission of the PUSCH or the PUCCH. For example, the base station apparatus 1A uses the SRS to measure an uplink channel state.

In FIG. 1, in downlink wireless communication from the base station apparatus 1A to the terminal apparatus 2A, the following downlink physical channels are used. The downlink physical channels are used to transmit the information that is output from the higher layer.

Physical Broadcast Channel (PBCH) (Broadcast Channel) Physical Control Format Indicator Channel (PCFICH) (Control Format Indicator Channel) Physical Hybrid automatic repeat request Indicator Channel (PHICH) (HARQ Indicator Channel)
Physical Downlink Control Channel (PDCCH) (Downlink Control Channel)
Enhanced Physical Downlink Control Channel (EPDCCH) (Enhanced Downlink Control Channel)
Physical Downlink Shared Channel (PDSCH) (Downlink Shared Channel).

The PBCH is used to broadcast a Master Information Block (MIB) (Broadcast Channel (BCH)) that is used in a shared manner in the terminal apparatus. The PCFICH is used to transmit information indicating a region (for example, the number of OFDM symbols) that is used for transmission of the PDCCH.

The PHICH is used to transmit an ACK or NACK of the uplink data (a transport block or a codeword) that is received by the base station apparatus 1A. That is, the PHICH is used to transmit an HARQ indicator (HARQ feedback) indicating the ACK or NACK of the uplink data. Furthermore, the ACK or NACK is also referred to as an HARQ-ACK. The terminal apparatus 2A notifies the higher layer of the received ACK or NACK. The ACK is an ACK indicating that reception is correctly performed. The NACK is a NACK indicating that reception is not correctly performed and is DTX indicating that corresponding data is not present. Furthermore, in a case where the PHICH for the uplink data is not present, the terminal apparatus 2A notifies the higher layer of the ACK.

The PDCCH and the EPDCCH are used to transmit Downlink Control Information (DCI). At this point, a plurality of DCI formats are defined for transmission of the Downlink Control Information. That is, a field for the Downlink Control Information is defined in a DCI format and is mapped to an information bit.

For example, DCI format 1A that is used for scheduling of one PDSCH (transmission of one downlink transport block) in one cell is defined as a DCI format for the downlink.

For example, information relating to PDSCH resource allocation, information relating to a Modulation and Coding Scheme (MCS) for the PDSCH, and the Downlink Control Information such as a TPC command for the PUCCH are included in the DCI format for the downlink. At this point, the DCI format for the downlink is also referred to as a downlink grant (or a downlink assignment).

Furthermore, for example, DCI format 0 that is used for scheduling of one PUSCH (transmission of one uplink transport block) in one cell is defined as a DCI format for uplink.

For example, information relating to PUSCH resource allocation, information relating to an MCS for the PUSCH, and Uplink Control Information such as a TPC command for the PUSCH are included in the DCI format for the uplink. The DCI format for the uplink is also referred to as an uplink grant (or an uplink assignment).

Furthermore, the DCI format for the uplink can be used to make a request (a CSI request) for the Channel State Information (CSI) (which is also referred to as received-quality information) for the downlink. The Rank Indicator (RI) indicating the suitable number of spatial multiplexes, the Precoding Matrix Indicator (PMI) indicating a suitable precoder, the Channel Quality Indicator (CQI) indicating a suitable transmission rate, a Precoding type Indicator (PTI) and the like correspond to the Channel State Information.

Furthermore, the DCI format for the uplink can be used for a configuration indicating an uplink resource to which a channel state information report (CSI feedback report) that is fed back by the terminal apparatus to the base station apparatus is mapped. For example, the channel state information report can be used for a configuration indicating an uplink resource in which Channel State Information (Periodic CSI) is periodically reported. The channel state information report can be used for a mode configuration (CSI report mode) in which the Channel State Information is periodically reported.

For example, the channel state information report can be used for a configuration indicating an uplink resource in which aperiodic Channel State Information (Aperiodic CSI) is reported. The channel state information report can be used for the mode configuration (the CSI report mode) in which the Channel State Information is aperiodically reported. The base station apparatus can configure either the periodic channel state information report or the aperiodic channel state information report. Furthermore, the base station apparatus can also configure both of the periodic channel state information report and the aperiodic channel state information report.

Furthermore, the DCI format for the uplink can be used for a configuration indicating a type of channel state information report that is fed back by the terminal apparatus to the base station apparatus. As types of channel state information reports, there are broadband CSI (for example, a Wideband CQI), narrowband CSI (for example, a Subband CQI), and the like.

In a case where a PDSCH resource is scheduled using the downlink assignment, the terminal apparatus receives the downlink data, on the scheduled PDSCH. Furthermore, in a case where a PUSCH resource is scheduled using the uplink grant, the terminal apparatus transmits the uplink data and/or the Uplink Control Information, on the scheduled PUSCH.

The PDSCH is used to transmit the downlink data (the downlink transport block or the DL-SCH). Furthermore, the PDSCH is used to transmit a system information block type-1 message. The system information block type-1 message is cell-specific (cell-peculiar) information.

Furthermore, the PDSCH is used to transmit a system information message. The system information message includes a system information block X other than the system information block type-1. The system information message is cell-specific (cell-peculiar) information.

Furthermore, the PDSCH is used to transmit the RRC message. At this point, the RRC message that is transmitted from the base station apparatus may be common to a plurality of terminal apparatuses within a cell. Furthermore, the RRC message that is transmitted from the base station apparatus 1A may be a message (which is also referred to as dedicated signaling) dedicated to a certain terminal apparatus 2. That is, UE-specific (UE-peculiar) information is transmitted using a message dedicated to a certain terminal apparatus. Furthermore, the PDSCH is used to transmit the MAC CE.

At this point, the RRC message and/or the MAC CE are also referred to as higher layer signaling.

Furthermore, the PDSCH can be used to make a request for the Channel State information for the downlink. Furthermore, the PDSCH can be used to transmit the uplink resource to which the channel state information report (the CSI feedback report) that is fed back by the terminal apparatus to the base station apparatus is mapped. For example, the channel state information report can be used for the configuration indicating the uplink resource in which the Channel State Information (the Periodic CSI) is periodically reported. The channel state information report can be used for the mode configuration (the CSI report mode) in which the Channel State Information is periodically reported.

As types of channel state information reports for the downlink, there are broadband CSI (for example, Wideband CSI), narrowband CSI (for example, Subband CSI), and the like. The broadband CSI results from calculating one piece of Channel State Information for a cell system band. The narrowband CSI results from dividing a system band by a predetermined unit into smaller ones and calculating one piece of Channel State Information for each of the smaller ones that results from the division.

Furthermore, in the downlink wireless communication, a synchronization signal (SS) and a Downlink Reference Signal (DL RS) are used as downlink physical signals. The downlink physical signal is not used to transmit the information that is output from the higher layer, but is used by the physical layer.

The synchronization signal is used for the terminal apparatus to be synchronized to a frequency domain for and a time domain for the downlink. Furthermore, the Downlink Reference Signal is used for the terminal apparatus to perform the channel reconfiguration of the downlink physical channel. For example, the Downlink Reference Signal is used for the terminal apparatus to calculate the Channel State Information for the downlink.

At this point, a Cell-specific Reference Signal (CRS), a UE-specific Reference Signal (URS) associated with the PDSCH, a Demodulation Reference Signal (DMRS) associated with the EPDCCH, a Non-Zero Power Chanel State Information-Reference Signal (NZP CSI-RS), and a Zero Power Chanel State Information-Reference Signal (ZP CSI-RS) are included in the Downlink Reference Signal.

The CRS is transmitted in all bands in a subframe, and is used for performing demodulation of the PBCH/PDCCH/PHICH/PCFICH/PDSCH. The URS associated with the PDSCH is transmitted in a subframe and a band that are used for transmission of the PDSCH with which the URS is associated, and is used for performing the demodulation of the PDSCH with which the URS is associated.

The DMRS that is associated with the EPDCCH is transmitted in a subframe and a band that are used for transmission of the EPDCCH with which the DMRS is associated. The DMRS is used to perform demodulation of the EPDCCH with which the DMRS is associated.

A resource for the NZP CSI-RS is configured by the base station apparatus 1A. For example, the terminal apparatus 2A performs signal measurement (channel measurement) using the NZP CSI-RS. A resource for the ZP CSI-RS is configured by the base station apparatus 1A. With a zero output, the base station apparatus 1A transmits the ZP CSI-RS. For example, the terminal apparatus 2A performs interference measurement on a resource to which the NZP CSI-RS corresponds.

A Multimedia Broadcast multicast service Single Frequency Network (MBSFN) RS is transmitted in all bands in a subframe that is used for transmission of a PMCH. The MBSFN RS is used to perform demodulation of the PMCH. The PMCH is transmitted in an antenna port that is used for transmission of the MBSFN RS.

At this point, the downlink physical channel and the downlink physical signal are also collectively referred to as a downlink signal. Furthermore, the uplink physical channel and the uplink physical signal are also collectively referred to as an uplink signal. Furthermore, the downlink physical channel and the uplink physical channel are also collectively referred to as a physical channel. Furthermore, the downlink physical signal and the uplink physical signal are also collectively referred to as a physical signal.

Furthermore, the BCH, the UL-SCH, and the DL-SCH are transport channels. A channel that is used in the MAC layer is referred to as a transport channel. Furthermore, a unit of a transport channel that is used in the MAC layer is also referred to as a Transport Block (TB) or a MAC Protocol Data Unit (PDU). The Transport Block is a unit of data that is delivered by the MAC layer to the physical layer. In the physical layer, the Transport Block is mapped to a codeword, and coding processing and the like are performed on every codeword.

The base station apparatus can multiplex a plurality of terminal apparatuses without dividing a resource that is a time, a frequency and a space (for example, an antenna port, a beam pattern, and a precoding pattern). Multiplexing of a plurality of terminal apparatuses without dividing time, frequency, and space resources is hereinafter referred to as non-orthogonal multiplexing. A case where two terminal apparatuses are non-orthogonally multiplexed will be described below, but without the present invention being limited to this, it is also possible that three or more terminal apparatuses are non-orthogonally multiplexed.

With reception from the base station apparatus or blind detection, the terminal apparatus 2A can detect a parameter necessary for removal or suppression of the interference signal. The removal or suppression of the interference signal is not necessarily required for the terminal apparatus 2B. In a case where the terminal apparatus 2B does not perform interference cancellation, because an interference signal power is comparatively low, the terminal apparatus 2B, although not knowing a parameter relating to the interference signal, can demodulate a signal that is transmitted to the terminal apparatus itself. More precisely, in a case where the base station apparatus 1A non-orthogonally multiplexes the terminal apparatuses 2A and 2B, it is desirable that the terminal apparatus 2A is provided with a function of removing or suppressing the interference signal by performing the non-orthogonal multiplexing, but the terminal apparatus 2B may be provided without a function of performing the interference removal or suppression. In other words, the base station apparatus 1A can non-orthogonally multiplex a terminal apparatus that supports the non-orthogonal multiplexing and a terminal apparatus that does not support the non-orthogonal multiplexing. Furthermore, in other words, the base station apparatus 1A can non-orthogonally multiplex terminal apparatuses for which different transmission modes are configured. Therefore, more opportunity for communication by each terminal apparatus can be created.

The base station apparatus 1A transmits information (assist information, supplementary information, control information, or configuration information) relating to a terminal apparatus (which, in this example, is the terminal apparatus 2B) that causes interference, to the terminal apparatus 2A. With the higher layer signaling or a physical layer signal (a control signal) (the PDCCH or the EPDCCH), the base station apparatus 1A can transmit the information (Network Assisted Interference Cancellation and Suppression (NAICS) information, NAICS assist information, NAICS configuration information, Multiuser (MU)-NAICS information, MU-NAICS assist information, MU-NAICS configuration information, Non Orthogonal Multiple Access (NOMA) information, NOMA assist information, and NOMA configuration information) relating to the terminal apparatus that causes the interference.

Included in the MU-NAICS assist information is part or all of information relating to PA, a transmission mode, information relating to a transmit power for the UE-specific Reference Signal, information relating to a transmit power for the PDSCH that causes the interference signal, a PMI, information relating to the PA in a serving cell, information relating to the transmit power for the UE-specific Reference Signal in the serving cell, a modulation scheme, a Modulation and Coding Scheme (MCS), a redundancy version, and a Radio Network Temporary Identifier (RNTI).

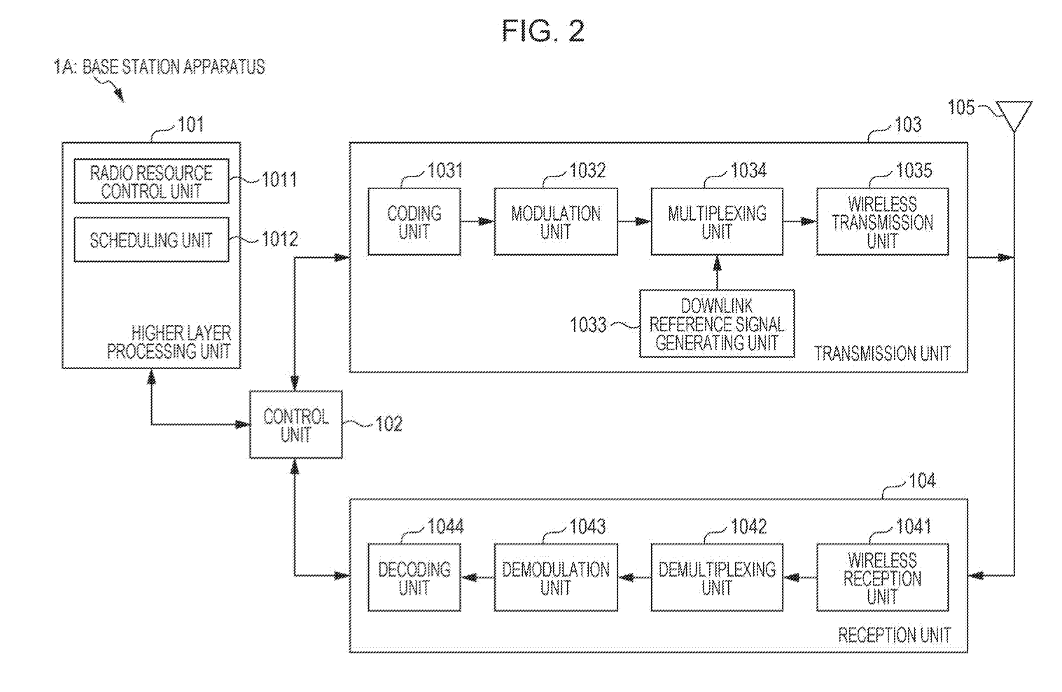

FIG. 2 is a schematic block diagram illustrating a constitution of the base station apparatus 1A according to the present embodiment. As illustrated in FIG. 2, the base station apparatus 1A is constituted to include a higher layer processing unit (a higher layer processing step) 101, a control unit (a control step) 102, a transmission unit (a transmission step) 103, a reception unit (a reception step) 104, and a transmit and receive antenna 105. Furthermore, the higher layer processing unit 101 is constituted to include a radio resource control unit (a radio resource control step) 1011 and a scheduling unit (a scheduling step) 1012. Furthermore, the transmission unit 103 is constituted to include a coding unit (a coding step) 1031, a modulation unit (a modulation step) 1032, a downlink reference signal generating unit (a downlink reference signal generation step) 1033, a multiplexing unit (a multiplexing step) 1034, and a wireless transmission unit (a wireless transmission step) 1035. Furthermore, the reception unit 104 is constituted to include a wireless reception unit (a wireless reception step) 1041, a demultiplexing unit (a demultiplexing step) 1042, a demodulation unit (a demodulation step) 1043, and a decoding unit (a decoding step) 1044.

The higher layer processing unit 101 performs processing of the Medium Access Control (MAC) layer, a Packet Data Convergence Protocol (PDCP) layer, a Radio Link Control (RLC) layer, and the Radio Resource Control (RRC) layer. Furthermore, the higher layer processing unit 101 generates information necessary to perform control of the transmission unit 103 and the reception unit 104, and outputs the generated information to the control unit 102.

The higher layer processing unit 101 receives information relating to the terminal apparatus, such as a function (UE capability) of the terminal apparatus, from the terminal apparatus. In other words, the terminal apparatus transmits the function of the terminal apparatus's own to the base station apparatus using the higher layer signaling.

It is noted that, as will be described below, information relating to the terminal apparatus includes information indicating whether or not the terminal apparatus supports a predetermined function, and information indicating completion of introduction and test of the predetermined function by the terminal apparatus. It is noted that, as will be described below, whether or not the predetermined function is supported includes whether or not the introduction and the test of the predetermined function are completed.

For example, in a case where the terminal apparatus supports the predetermined function, the terminal apparatus transmits the information (a parameter) indicating whether or not the predetermined function is supported. In a case where the terminal apparatus does not support the predetermined function, the terminal apparatus does not transmit the information (the parameter) indicating whether or not the predetermined function is supported. That is, whether or not the predetermined function is supported is notified depending on whether or not the information (the parameter) indicating whether or not the predetermined function is supported is transmitted. It is noted that the information (the parameter) indicating whether or not the predetermined function is supported may be notified using one bit, that is, a bit that is 0 or a bit that is 1.

The radio resource control unit 1011 generates or acquires from a higher node the downlink data (the Transport Block) that is mapped to the PDSCH for the downlink, the system information, the RRC message, the MAC CE, and the like. The radio resource control unit 1011 outputs the downlink data to the transmission unit 103, and outputs other information to the control unit 102. Furthermore, the radio resource control unit 1011 manages various pieces of configuration information of the terminal apparatus.

The scheduling unit 1012 determines a frequency and a subframe to which the physical channels (the PDSCH and PUSCH) are allocated, coding rates and modulation schemes (or the MCSs) of and for the physical channels (the PDSCH and the PUSCH), a transmit power, and the like. The scheduling unit 1012 outputs the determined information to the control unit 102.

The scheduling unit 1012 generates information that is used for scheduling of the physical channels (the PDSCH and the PUSCH), based on a result of the scheduling. The scheduling unit 1012 outputs the generated information to the control unit 102.

Based on information that is input from the higher layer processing unit 101, the control unit 102 generates a control signal for performing the control of the transmission unit 103 and the reception unit 104. The control unit 102 generates the Downlink Control Information, based on the information that is input from the higher layer processing unit 101, and outputs the generated Downlink Control Information to the transmission unit 103.

The transmission unit 103 generates the Downlink Reference Signal in accordance with the control signal that is input from the control unit 102, codes and modulates the HARQ indicator, the Downlink Control Information, and the downlink data, which are input from the higher layer processing unit 101, multiplexes the PHICH, the PDCCH, the EPDCCH, the PDSCH, and the Downlink Reference Signal, and transmits the resulting signal to the terminal apparatus 2 through the transmit and receive antenna 105.

The coding unit 1031 performs coding on the HARQ indicator, the Downlink Control Information, and the downlink data, which are input from the higher layer processing unit 101. When performing the coding, the coding unit 1031 uses a coding scheme that is determined in advance, such as block coding, convolutional coding, or turbo coding, or uses a coding scheme that is determined by the radio resource control unit 1011. The modulation unit 1032 performs modulation on coding bits that are input from the coding unit 1031, using a modulation scheme that is determined in advance, such as Binary Phase Shift Keying (BPSK), quadrature Phase Shift Keying (QPSK), 16 quadrature amplitude modulation (QAM), 64 QAM, or 256 QAM, or using a modulation scheme that is determined by the radio resource control unit 1011.

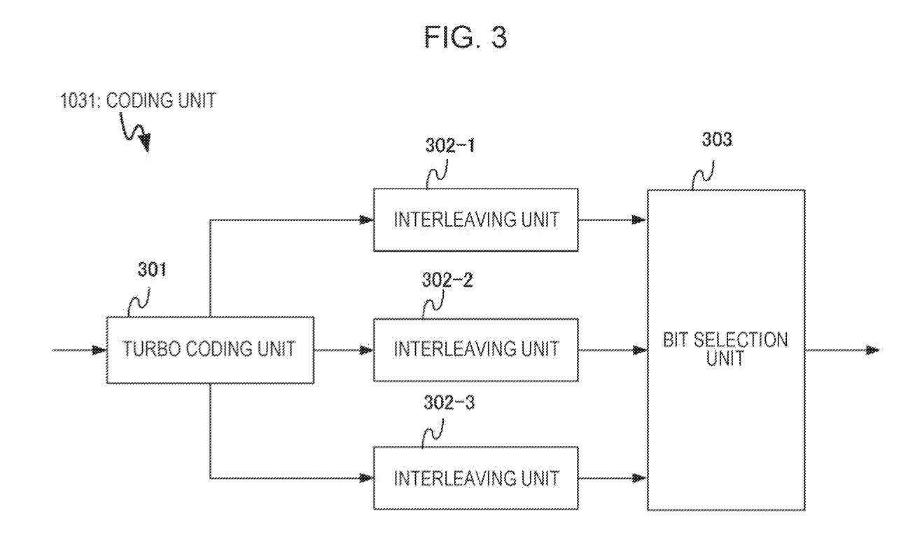

FIG. 3 is a schematic block diagram illustrating an example of a constitution of the coding unit 1031. At this point, a case where error correction coding is performed using a turbo code is described. The coding unit includes a turbo coding unit 301, interleaving units 302-1 to 302-3, and a bit selection unit 303. The turbo coding unit 301 performs coding at a certain coding rate. At this point, a case where the coding is performed at a coding rate of 1/3 is described. At this time, the turbo coding unit 301 outputs threes sequences, that is, a systematic bit sequence, a first parity bit sequence, and a second parity bit sequence. The interleaving units 302-1 to 302-3 each are sub-block interleavers that interleave the systematic bit sequence, the first parity bit sequence, and the second parity bit sequence. The interleaving units 302-1 to 302-3 are three blocks for performing parallel processing, but in a case where serial processing is performed, one interleaving unit may be sufficient. The bit selection unit 303 punctures a bit sequence in such a manner that a rate which is determined by an RV, rate matching, or the like results and outputs the bit sequence to be transmitted. It is noted that a coding bit sequence is kept retained until the terminal apparatus can correctly receive information data. The coding bit sequence that is kept retained can be used for an HARQ.

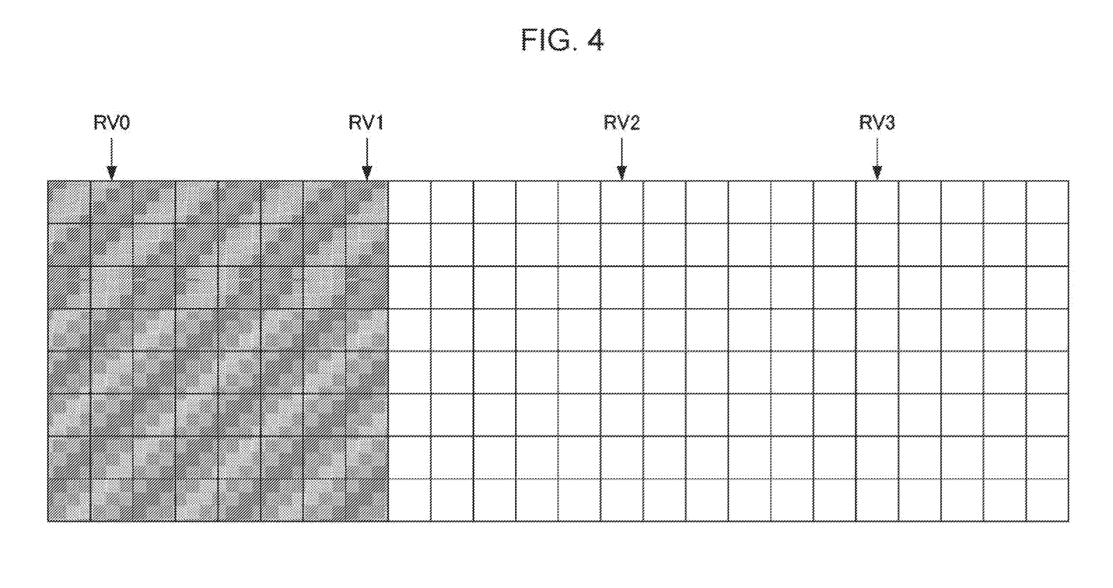

FIG. 4 is a diagram for describing processing by the bit selection unit 303. Post-interleaving coding bits are arranged in a quadrangle in FIG. 4. Systematic bit sequences are arranged in an area shown by oblique lines. The first parity bit sequence and the second parity bit sequence are alternately arranged in white blank areas. With respect to the bit sequences that are arranged, the number of bits needed as starting positions that is determined according to an RV value is read.

For example, in Long Term Evolution (LTE), there are 4 RVs. At this point, 4 RVs are expressed as RV0 to RV3. It is noted that RV0 to RV 3 indicate RV values of 0, 1, 2, and 3, respectively. Furthermore, among RVs, RV0 includes the largest number of systematic bits. The bit selection unit determines which RV to be used, according to retransmission request signal that is notified by the terminal apparatus. Normally, in a case where initial transmission is requested, RV0 is used. In a case where retransmission is requested, any one of RV0 to RV3 is used.

The downlink reference signal generating unit 1033 generates as the Downlink Reference Signal a sequence that is already known to the terminal apparatus 2A, which is obtained according to a rule that is determined in advance based on a physical cell identity (PCI) (a cell ID) for identifying the base station apparatus 1A, and the like.

A multiplexing unit 1034 multiplexes a modulation symbol of each channel, which results from the modulation, and the Downlink Reference Signal and the Downlink Control Information, which are generated. More precisely, the multiplexing unit 1034 maps the modulation symbol of each channel, which results from the modulation, and the Downlink Reference Signal and the Downlink Control Information, which are generated, to resource elements.

The wireless transmission unit 1035 performs Inverse Fast Fourier Transform (IFFT) on a modulation symbol and the like that result from the multiplexing, generates an OFDM symbol, attaches a cyclic prefix (CP) to the OFDM symbol, generates a digital signal in a baseband, converts the digital signal in the baseband into an analog signal, removes superfluous frequency components by perform filtering, performs up-converting into a carrier frequency, performs power amplification, and outputs a final result to the transmit and receive antenna 105 for transmission.

In accordance with the control signal that is input from the control unit 102, the reception unit 104 outputs information, which results from demultiplexing, demodulating, and decoding a reception signal that is received from the terminal apparatus 2A through the transmit and receive antenna 105, to the higher layer processing unit 101.

The wireless reception unit 1041 converts an uplink signal that is received through the transmit and receive antenna 105, into a signal in a baseband by performing down-converting, removes an unnecessary frequency component, controls an amplification level in such a manner that a signal level is suitably maintained, performs orthogonal demodulation based on an in-phase component and an orthogonal component of the received signal, and converts an analog signal that results from the orthogonal demodulation, into a digital signal.

The wireless reception unit 1041 removes a portion that is equivalent to the CP from the digital signal that results from the conversion. The wireless reception unit 1041 performs Fast Fourier Transform (FFT) on the signal from which the CP is removed, extracts a signal in the frequency domain, and outputs the extracted signal to the demultiplexing unit 1042.

The demultiplexing unit 1042 demultiplexes the signal that is input from the wireless reception unit 1041 into the PUCCH, the PUSCH, and the signal such as the Uplink Reference Signal. It is noted that the demultiplexing is performed based on radio resource allocation information that is determined in advance by the base station apparatus 1A, using the radio resource control unit 1011, and that is included in the uplink grant that is notified to each terminal apparatus 2.

Furthermore, the demultiplexing unit 1042 performs channel compensation on the PUCCH and the PUSCH. Furthermore, the demultiplexing unit 1042 demultiplexes the Uplink Reference Signal.

A demodulation unit 1043 performs Inverse Discrete Fourier Transform (IDFT) on the PUSCH, acquires the modulation symbol, and performs reception signal demodulation on each of the modulation symbols on the PUCCH and the PUSCH, using the modulation scheme that is determined in advance, such as BPSK, QPSK, 16 QAM, 64 QAM, or 256 QAM, or using the modulation scheme that is notified, in advance, with the uplink grant, to each terminal apparatus 2 by the base station apparatus 1A itself.

A decoding unit 1044 performs the decoding on coding bits of the PUCCH and the PUSCH that result from the demodulation, at a coding rate in compliance with the coding scheme that is determined in advance, which is determined in advance, or at a coding rate which is notified in advance with the uplink grant to the terminal apparatus 2 by the base station apparatus 1A itself, and outputs the uplink data and the Uplink Control Information that result from the decoding, to the higher layer processing unit 101. In the case of retransmission of the PUSCH, the decoding unit 1044 performs the decoding using the coding bits that are input from the higher layer processing unit 101 and that are retained in an HARQ buffer, and the coding bits that result from the demodulation.

An example of operation of the modulation unit 1032 of the base station apparatus 1A according to the present embodiment is described taking as an example a case where the base station apparatus 1A non-orthogonally multiplexes the terminal apparatus 2A and the terminal apparatus 2B. The base station apparatus 1A transmits the PDSCH (a first PDSCH or PDSCH 1) to the terminal apparatus 2A, using a first modulation scheme. Furthermore, the base station apparatus 1A transmits the PDSCH (a second PDSCH or PDSCH 2) to the terminal apparatus 2B, using a second modulation scheme. The first modulation scheme and the second modulation scheme may be the same, and may be different from each other. The first modulation scheme and the second modulation scheme are described below as 16 QAM and QPSK, respectively.

The base station apparatus 1A can allocate different transmit powers to a transmit signal that is transmitted to the terminal apparatus 2A and a transmit signal that is transmitted to the terminal apparatus 2B, for transmission. For example, in the following description, a case where a power for transmission of PDSCH 2 to the terminal apparatus 2B is higher than a power for transmission of PDSCH 1 to the terminal apparatus 2A is described.

The base station apparatus 1A can determine whether or not the transmit signal that is transmitted to the terminal apparatus 2A and the transmit signal that is transmitted to the terminal apparatus 2B are non-orthogonally multiplexed and are transmitted, according to a retransmission state of the transmit signal that is transmitted to the terminal apparatus 2A. For example, in a case where the transmit signal that is transmitted to the terminal apparatus 2A is an initial transmit signal, the base station apparatus 1A can transmit the transmit signal that is transmitted to the terminal apparatus 2B, in a state of being non-orthogonally multiplexed onto the transmit signal that is transmitted to the terminal apparatus 2A. On the other hand, in a case where the transmit signal that is transmitted to the terminal apparatus 2A is a retransmit signal, the base station apparatus 1A can transmit a transmit signal that is transmitted to another terminal apparatus, without being non-orthogonally multiplexed onto the transmit signal that is transmitted to the terminal apparatus 2A.

At this point, the initial transmit signal refers to a signal that includes a coding bit that is initially transmitted, in the coding bit sequence that results from coding information bits which are transmitted by the base station apparatus 1A to the terminal apparatus 2A.

The base station apparatus 1A can include information indicating the retransmission state of the transmit signal that is transmitted to the terminal apparatus 2A, in the control information that is transmitted on the PDCCH or the like to the terminal apparatus 2A. For example, the base station apparatus 1A can include New Data Indicator (NDI) in the control information that is transmitted to the terminal apparatus 2A. In a case where the NDI that the base station apparatus 1A includes in the control information which is addressed to the terminal apparatus 2A is “1”, the base station apparatus 1A can transmit the transmit signal that is transmitted to another terminal apparatus (for example, the terminal apparatus 2B), in a state of being non-orthogonally multiplexed onto the transmit signal that is transmitted to the terminal apparatus 2A. On the other hand, in a case where the NDI that the base station apparatus 1A includes in the control information which is addressed to the terminal apparatus 2A is “0”, the base station apparatus 1A can transmit the transmit signal that is transmitted to another terminal apparatus (for example, the terminal apparatus 2B), without being non-orthogonally multiplexed onto the transmit signal that is transmitted to the terminal apparatus 2A.

Furthermore, the base station apparatus 1A can transmit the RV in a state of being included in the control information that is addressed to the terminal apparatus 2A. In a case where the RV that the base station apparatus 1A includes in the control information which is addressed to the terminal apparatus 2A is “0” (that is, in a case where the transmit signal is coding bits that include the most systematic bit), the base station apparatus 1A can transmit the transmit signal that is transmitted to another terminal apparatus (for example, the terminal apparatus 2B), in a state of being non-orthogonally multiplexed onto the transmit signal that is transmitted to the terminal apparatus 2A. On the other hand, in a case where the RV that the base station apparatus 1A includes in the control information which is addressed to the terminal apparatus 2A is other than “0”, the base station apparatus 1A can transmit the transmit signal that is transmitted to another terminal apparatus (for example, the terminal apparatus 2B), without being non-orthogonally multiplexed onto the transmit signal that is transmitted to the terminal apparatus 2A.

Furthermore, the base station apparatus 1A can transmit information indicating a multiplexed state of the transmit signal that is transmitted to the terminal apparatus 2A (that is, whether or not the transmit signal that is transmitted to another terminal apparatus is non-orthogonally multiplexed onto the transmit signal that is transmitted to the terminal apparatus 2A), to the terminal apparatus 2A. For example, the base station apparatus 1A can include information indicating a transmission mode, in the control information that is transmitted to the terminal apparatus 2A. At this point, in a case where the base station apparatus 1A notifies the terminal apparatus 2A of information indicating a predetermined transmission mode and where in the predetermined transmission mode, it is possible that the base station apparatus 1A non-orthogonally multiplexes the transmit signal that is transmitted to another terminal apparatus, onto the transmit signal that is transmitted to the terminal apparatus 2A, the base station apparatus 1A can determine whether or not the transmit signal that is transmitted to another terminal apparatus is non-orthogonally multiplexed onto the transmit signal that is transmitted to the terminal apparatus 2, according to the retransmission state of the transmit signal that is transmitted to the terminal apparatus 2A, which is described above.

It is noted that the information indicating the multiplexed state of the transmit signal, which is notified by the base station apparatus 1A to the terminal apparatus 2A, is not limited to the transmission mode, but for example, the control information that is notified with the higher layer such as RRC signaling is also included in the present embodiment.

Furthermore, only in a case where each of the information indicating the multiplexed state of the transmit signal that is transmitted to the terminal apparatus 2A and the information indicating the retransmission state of the transmit signal that is transmitted to the terminal apparatus 2A indicates a predetermined state, it is possible that the base station apparatus 1A non-orthogonally multiplexes the transmit signal that is transmitted to another terminal apparatus, onto the transmit signal that is transmitted to the terminal apparatus 2A. For example, in a case where the base station apparatus 1A notifies the terminal apparatus 2A of a predetermined transmission mode and where the information indicating the retransmission state of the transmit signal that is transmitted to the terminal apparatus 2A, which is notified to the terminal apparatus 2A, indicates that the transmit signal is an initial transmit signal (for example, the NDI is “1”), it is possible that the base station apparatus 1A non-orthogonally multiplexes the transmit signal that is transmitted to another terminal apparatus, onto the transmit signal that is transmitted to the terminal apparatus 2A.

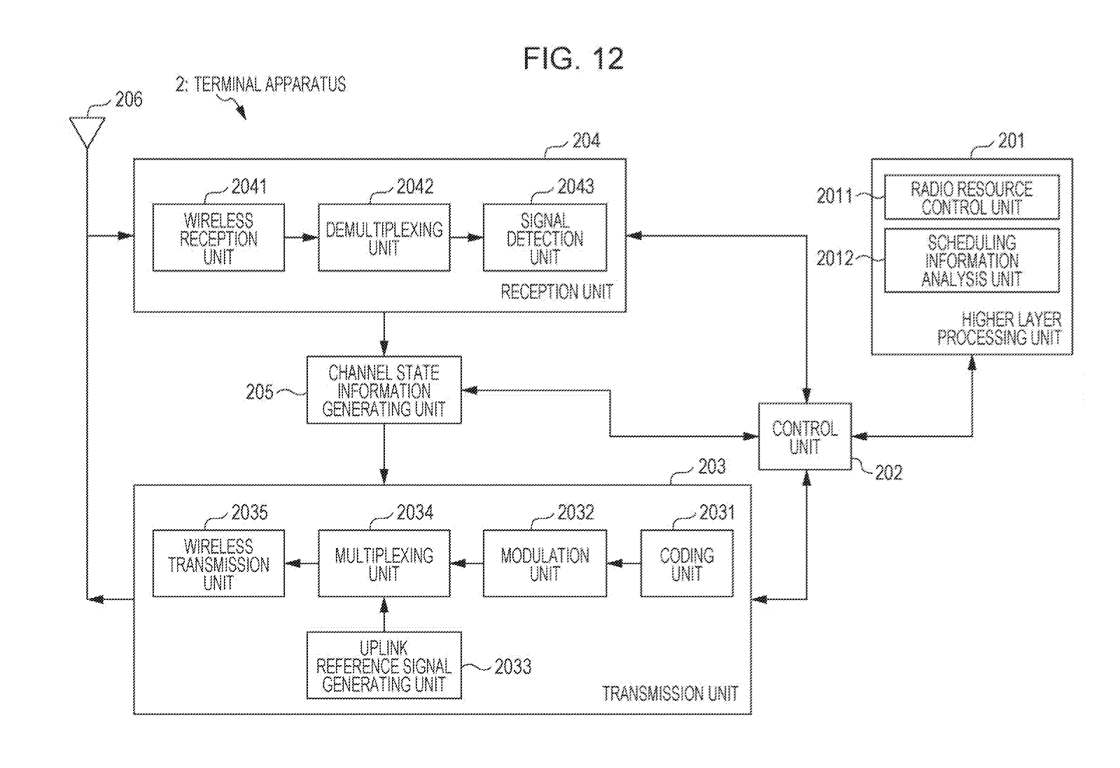

FIG. 12 is a schematic block diagram illustrating a constitution of the terminal apparatus 2 according to the present embodiment. As illustrated in FIG. 12, the terminal apparatus 2A is constituted to include a higher layer processing unit (a higher layer processing step) 201, a control unit (a control step) 202, a transmission unit (a transmission step) 203, a reception unit (a reception step) 204, a channel state information generating unit (a channel state information generation step) 205, and a transmit and receive antenna 206. Furthermore, the higher layer processing unit 201 is constituted to include a radio resource control unit (a radio resource control step) 2011 and a scheduling information analysis unit (a scheduling information analysis step) 2012. Furthermore, the transmission unit 203 is constituted to include a coding unit (a coding step) 2031, a modulation unit (a modulation step) 2032, an uplink reference signal generating unit (an uplink reference signal generation step) 2033, a multiplexing unit (a multiplexing step) 2034, and a wireless transmission unit (a wireless transmission step) 2035. Furthermore, the reception unit 204 is constituted to include a wireless reception unit (a wireless reception step) 2041, a demultiplexing unit (a demultiplexing step) 2042, and a signal detection unit (a signal detection step) 2043.

The higher layer processing unit 201 outputs the uplink data (the Transport Block) that is generated by a user operation and the like, to the transmission unit 203. Furthermore, the higher layer processing unit 201 performs the processing of the Medium Access Control (MAC) layer, the Packet Data Convergence Protocol (PDCP) layer, the Radio Link Control (RLC) layer, and the Radio Resource Control (RRC) layer.

The higher layer processing unit 201 outputs information indicating the function of the terminal apparatus, which is supported by the terminal apparatus itself, to the transmission unit 203.

The radio resource control unit 2011 manages various pieces of configuration information of the terminal apparatus itself. Furthermore, the radio resource control unit 2011 generates information that is mapped to each channel in the uplink and outputs the generated information to the transmission unit 203.

The radio resource control unit 2011 acquires configuration information relating to CSI feedback, which is transmitted from the base station apparatus, and outputs the acquired configuration information to the control unit 202.

The scheduling information analysis unit 2012 analyzes the Downlink Control Information that is received through the reception unit 204 and determines scheduling information. Furthermore, the scheduling information analysis unit 2012 generates the control information in order to perform the control of the reception unit 204 and the transmission unit 203 based on the scheduling information, and outputs the generated control information to the control unit 202.

Based on the information that is input from the higher layer processing unit 201, the control unit 202 generates a control signal for performing the control of the reception unit 204, the channel state information generating unit 205, and the transmission unit 203. The control unit 202 outputs the generated control signal to the reception unit 204, the channel state information generating unit 205, and the transmission unit 203 and performs the control of the reception unit 204 and the transmission unit 203.

The control unit 202 controls the transmission unit 203 in such a manner that the CSI which is generated by the channel state information generating unit 205 is transmitted to the base station apparatus.

In accordance with the control signal that is input from the control unit 202, the reception unit 204 outputs information, which results from demultiplexing, demodulating, and decoding a reception signal that is received from the base station apparatus 1A through the transmit and receive antenna 206, to the higher layer processing unit 201.

The wireless reception unit 2041 converts a downlink signal that is received through the transmit and receive antenna 206, into a signal in a baseband by performing down-converting, removes an unnecessary frequency component, controls an amplification level in such a manner that a signal level is suitably maintained, performs orthogonal demodulation based on an in-phase component and a quadrature component of the received signal, and converts an analog signal that results from the orthogonal demodulation, into a digital signal.

Furthermore, the wireless reception unit 2041 removes a portion that is equivalent to the CP from the digital signal that results from the conversion, performs the Fast Fourier Transform on the signal from which the CP is removed, and extracts a signal in the frequency domain.

The demultiplexing unit 2042 demultiplexes a signal that results from the extraction, into the PHICH, the PDCCH, the EPDCCH, the PDSCH, and the Downlink Reference Signal. Furthermore, the demultiplexing unit 2042 performs channel compensation on the PHICH, the PDCCH, and the EPDCCH based on a channel estimate of a desired signal that is acquired from channel measurement, detects the Downlink Control Information, and outputs the detected Downlink Control Information to the control unit 202. Furthermore, the control unit 202 outputs the PDSCH and a channel estimate of the desired signal to the signal detection unit 2043.

The signal detection unit 2043 performs the signal detection using the PDSCH and the channel estimate, and outputs a result of the signal detection to the higher layer processing unit 201.

The transmission unit 203 generates the Uplink Reference Signal in accordance with the control signal, which is input from the control unit 202, performs the coding and the modulation on the uplink data (the Transport Block), which is input from the higher layer processing unit 201, multiplexes the PUCCH, the PUSCH, and the generated Uplink Reference Signal, and transmits a result of the multiplexing to the base station apparatus 1A through the transmit and receive antenna 206.

The coding unit 2031 performs the coding, such as the convolutional coding or the block coding, on the Uplink Control Information that is input from the higher layer processing unit 201. Furthermore, the coding unit 2031 performs the turbo coding, based on information that is used for scheduling of the PUSCH.

The modulation unit 2032 performs the modulation on coding bits, which are input from the coding unit 2031, in compliance with a modulation scheme that is notified with the Downlink Control Information, such as BPSK, QPSK, 16 QAM, or 64 QAM, or in compliance with a modulation scheme that is determined in advance for every channel.

The uplink reference signal generating unit 2033 generates a sequence that is obtained according to a rule (formula) which is determined in advance, based on the physical cell identity (PCI) (which is referred to as the Cell ID or the like) for identifying the base station apparatus 1A, a bandwidth to which the Uplink Reference Signal is mapped, a cyclic shift that is notified with the uplink grant, a parameter value for generation of a DMRS sequence, and the like.

In accordance with the control signal that is input from the control unit 202, the multiplexing unit 2034 re-maps the modulation symbols on the PUSCH in parallel and then performs Discrete Fourier Transform (DFT) on the re-mapped modulation symbols. Furthermore, the multiplexing unit 2034 multiplexes PUCCH and PUSCH signals and the generated Uplink Reference Signal for every transmit antenna port. More precisely, the multiplexing unit 2034 maps the PUCCH and PUSCH signals and the generated Uplink Reference Signal to resource elements for every transmit antenna port.

The wireless transmission unit 2035 performs the Inverse Fast Fourier Transform (IFFT) on a signal that results from the multiplexing, performs modulation in compliance with an SC-FDMA scheme on the resulting signal, generates an SC-FDMA symbol, attaches a CP to the generated SC-FDMA symbol, generates a digital signal in a baseband, converts the digital signal in the baseband into an analog signal, removes superfluous frequency components, performs up-converting into a carrier frequency, performs the power amplification, and outputs a final result to the transmit and receive antenna 206 for transmission.

It is possible that the signal detection unit 2043 according to the present embodiment performs demodulation processing based on the information relating to the multiplexed state of the transmit signal that is transmitted to the terminal apparatus itself and the information relating to the retransmission state of the transmit signal that is transmitted to the terminal apparatus itself.

The signal detection unit 2043 can acquire the NDI that is notified by the base station apparatus 1A, as the information relating to the retransmission state of the transmit signal that is transmitted to the terminal apparatus itself. In a case where the NDI indicates that the transmit signal is an initial transmit signal (that is, the NDI is “1”), the signal detection unit 2043 can analyze this to mean that the transmit signal that is transmitted to another terminal apparatus is non-orthogonally multiplexed onto the transmit signal that is transmitted to the terminal apparatus itself, and thus can perform the demodulation processing. Specifically, the signal detection unit 2043 can perform the demodulation processing for regarding a signal that is transmitted to another terminal apparatus as the interference signal and for removing or suppressing the interference signal, on a non-orthogonal multiplexing signal that results from non-orthogonally multiplexing the transmit signal that is transmitted to another terminal apparatus (for example, the terminal apparatus 2B) onto the transmit signal that is transmitted to the terminal apparatus itself. On this occasion, in order to remove or suppress the interference signal, it is also possible that the signal detection unit 2043 uses Symbol Level Interference Cancellation (SLIC) that performs the interference removal according to a result of the demodulation of the interference signal, Codeword Level Interference Cancellation (CWIC) that performs the interference removal according to a result of the decoding of the interference signal, Maximum Likelihood Detection (MLD) that searches for the most similar one, among transmit signal candidates, and the like.

The signal detection unit 2043 can acquire the RV that is notified by the base station apparatus 1A, as the information relating to the retransmission state of the transmit signal that is transmitted to the terminal apparatus itself. In a case where the RV indicates an RV that includes the most systematic bit, the signal detection unit 2043 can analyze this to mean that the transmit signal that is transmitted to another terminal apparatus is non-orthogonally multiplexed onto the transmit signal that is transmitted to the terminal apparatus itself, and thus can perform the demodulation processing.

The signal detection unit 2043 can acquire the information indicating the transmission mode that is notified by the base station apparatus 1A, as the information relating to the multiplexed state of the transmit signal that is transmitted to the terminal apparatus itself. For example, in a case where the information indicating the transmission mode indicates a predetermined transmission mode, the signal detection unit 2043, as described above, can perform the demodulation processing, based on the information relating to the retransmission state of the transmit signal that is transmitted to the terminal apparatus itself. At this point, the predetermined mode refers to a transmission mode that enables the terminal apparatus 2A to receive the non-orthogonal multiplexing signal that results from non-orthogonally multiplexing the transmit signal that is transmitted to another terminal apparatus onto the transmit signal that is transmitted to the terminal apparatus 2A itself. Furthermore, it is possible that the terminal apparatus 2A acquires the information relating to the multiplexed state of the transmit signal that is transmitted to the terminal apparatus 2A itself, based on the information that is notified with the higher layer such as the RRC signaling.

Furthermore, only in the case where each of the information indicating the multiplexed state of the transmit signal that is transmitted to the terminal apparatus itself and the information indicating the retransmission state of the transmit signal that is transmitted to the terminal apparatus itself indicates a predetermined state, the signal detection unit 2043 analyzes this to mean that the transmit signal that is transmitted to another terminal apparatus is non-orthogonally multiplexed on the transmit signal that is transmitted to the terminal apparatus itself, and thus can perform the demodulation processing. For example, in a case where the information indicating the transmission mode that is notified to the signal detection unit 2043 indicates a predetermined transmission mode (for example, a transmission mode that enables the terminal apparatus 2A to receive the non-orthogonal multiplexing signal) and where the information indicating the retransmission state of the transmit signal that is transmitted to the terminal apparatus itself indicates that the transmit signal is an initial transmit signal (for example, that the NDI is “1”), the signal detection unit 2043 analyzes this to mean that the transmit signal that is transmitted to another terminal apparatus is non-orthogonally multiplexed onto the transmit signal that is transmitted to the terminal apparatus itself, and thus possibly performs the demodulation processing.

When it comes to the base station 1A and the terminal apparatus 2A as described above, the base station apparatus 1A can determine whether or not the transmit signal that is transmitted to another terminal apparatus is non-orthogonally multiplexed onto the transmit signal that is transmitted to the terminal apparatus 2A, based on the information indicating the multiplexed state of the transmit signal that is transmitted to the terminal apparatus 2A itself and the information indicating the retransmission state of the transmit signal that is transmitted to the terminal apparatus 2A itself, and the terminal apparatus 2A analyzes whether or not the transmit signal that is transmitted to another terminal apparatus is non-orthogonally multiplexed onto the transmit signal that is transmitted to the terminal apparatus 2A itself, based on the information indicating the multiplexed state of the transmit signal that is transmitted to the terminal apparatus 2A itself and the information indicating the retransmission state of the transmit signal that is transmitted to the terminal apparatus 2A itself, and thus possibly performs the demodulation processing. Because of this, it is possible that the base station apparatus 1A performs flexible radio resource allocation and that the terminal apparatus 2A performs suitable demodulation processing. This can contribute to an improvement in frequency efficiency of the communication system.

### 2. Second Embodiment

In the present embodiment, the base station apparatus 1A uses a mapping method that is used when the transmit signal that is transmitted to the terminal apparatus 2A is modulated, as the information indicating the multiplexed state of the transmit signal that is transmitted to the terminal apparatus 2A. It is noted that a constitution of the base station apparatus 1A and a constitution of the terminal apparatus 2A are the same as those in the first embodiment.

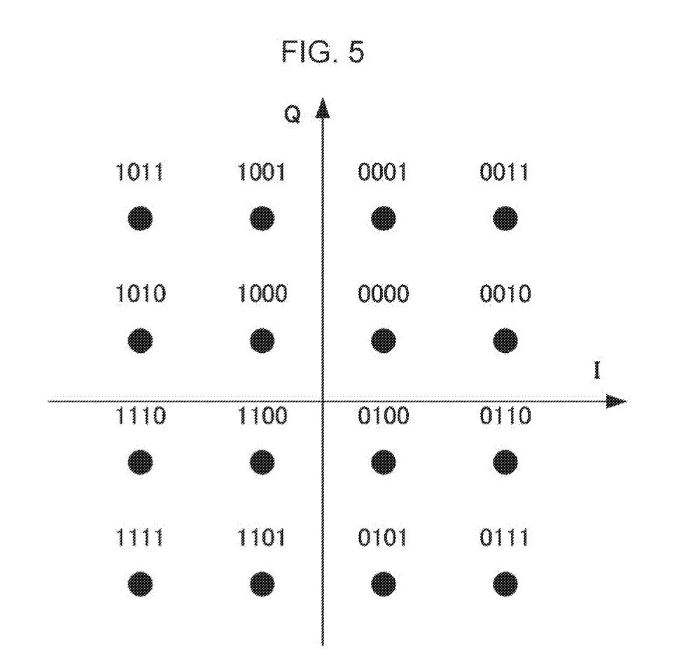

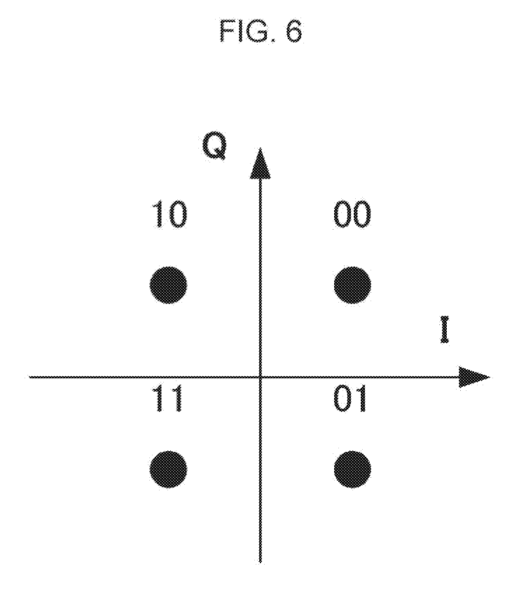

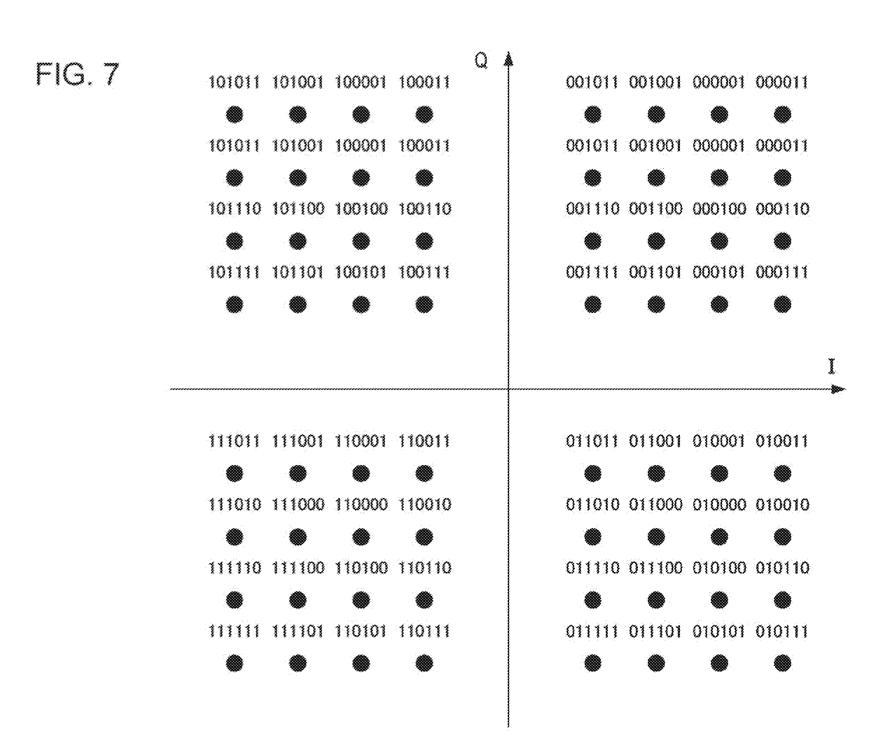

First, an example in the related art is described. FIG. 5 is a schematic diagram illustration an example of modulation signal points (modulation mapping) in a first modulation scheme. Furthermore, FIG. 6 is a schematic diagram illustrating an example of modulation signal points (modulation mapping) in a second modulation scheme. FIG. 7 is a schematic diagram illustrating an example of modulation signal points in a case where the base station apparatus 1A non-orthogonally multiplexes PDSCH 1 and PDSCH 2. In this case, in all, there are 64 modulation signal points that have a likelihood of being transmitted by the base station apparatus 1A. For example, in a case where the base station apparatus 1A transmits 4-bit information (transmission bits) that is “0011” which are addressed to the terminal apparatus 2A, 2-bit information that is “11’ which is addressed to the terminal apparatus 2B, the base station apparatus 1A modulates (maps) the transmission bits, which are addressed to the terminal apparatus 2A and the terminal apparatus 2B, onto a modulation signal point that is labeled as “110011” in FIG. 7, for transmission. Transmission bits that result from combining the transmission bits that are addressed to the terminal apparatus 1A and the transmission bits that are addressed to the terminal apparatus 2A are hereinafter referred to as composite bits. Furthermore, the labeling of composite bits is described using an example in which the labeling starts with the transmission bits that are addressed to the terminal apparatus 2B. That is, when what is described above is taken as an example, in 6 bits that are composite bits, two most significant bits are transmission bits that are addressed to the terminal apparatus 2B, and 4 least significant bits are transmission bits that are addressed to the terminal apparatus 2A. It is noted that a method of constituting the composite bits is not limited to this, and for example, the mapping may start from the transmission bits that are addressed to the terminal apparatus 2A.

It is noted that because in some cases, the base station apparatus 1A performs transmit power control, as described above, on PDSCH 1 and PDSCH 2, there is a case where an actual distance between each of the signal points is different from that which is illustrated in FIG. 7.

Each of the terminal apparatus 2A and the terminal apparatus 2B each receives the modulation symbol that is transmitted by the base station apparatus 1A. The terminal apparatus 2B demodulates 2-bit information that is transmitted to the terminal apparatus 2B itself, from the modulation symbol. At this point, as illustrated in FIG. 7, in a case where the base station apparatus 1A provides a higher transmit power to PDSCH 2 than to PDSCH 1, in 64 modulation signal points that are received by the terminal apparatus 2B, there are 16 modulation signal points in compliance with 16 QAM that the base station apparatus 1A applies to PDSCH 1, with 4 modulation signal points in compliance with QPSK, which the base station apparatus 1A applies to PDSCH 2, being the middle thereof. Consequently, the terminal apparatus 2B determines which quadrant of the signal point space the received signal belongs to, and thus can demodulate 2-bit information that is addressed to the terminal apparatus 2B itself. That is, it is possible that the terminal apparatus 2B demodulates a signal which is transmitted to the terminal apparatus 2B itself, without determining whether or not the signal that is transmitted to another apparatus is non-orthogonally multiplexed onto the signal that is transmitted to the terminal apparatus 2B itself. Of course, although the terminal apparatus 2B, like the terminal apparatus 2A that will be described below, detects the signal that is transmitted to another apparatus and then demodulates the signal that is transmitted to the terminal apparatus 2B itself, this does not matter.

On the other hand, in order to demodulate the 4-bit information that is addressed to the terminal apparatus 2A itself, the terminal apparatus 2A has to demodulate the 2-bit information that is addressed to the terminal apparatus 2B, from the modulation symbol that is transmitted by the base station apparatus 1A, and has to determine which quadrant the 4-bit information that is addressed to the terminal apparatus 2A itself belongs to. This method has no limitation whatsoever, but for example, the terminal apparatus 2A can calculate modulation signal candidate points (for example, 64 points in FIG. 7) that have a likelihood of being received, based on the modulation scheme that is used by the base station apparatus 1A for PDSCH 1 and PDSCH 2, and can extract the closest modulation signal candidate point to the reception signal. With this method, because the terminal apparatus 2A can demodulate the modulation symbol to which the base station apparatus 1A maps the composite bits, the terminal apparatus 2A can demodulate the 4-bit information that is addressed to the terminal apparatus 2A itself, from the modulation symbol that is demodulated. It is noted that because the terminal apparatus 2A regards the transmission bits that are addressed to the terminal apparatus 2B, which are included in the composite bits, as the interference signal, and removes or suppress the interference signal, it is also possible that interference suppression processing, such as the SLIC, is performed.

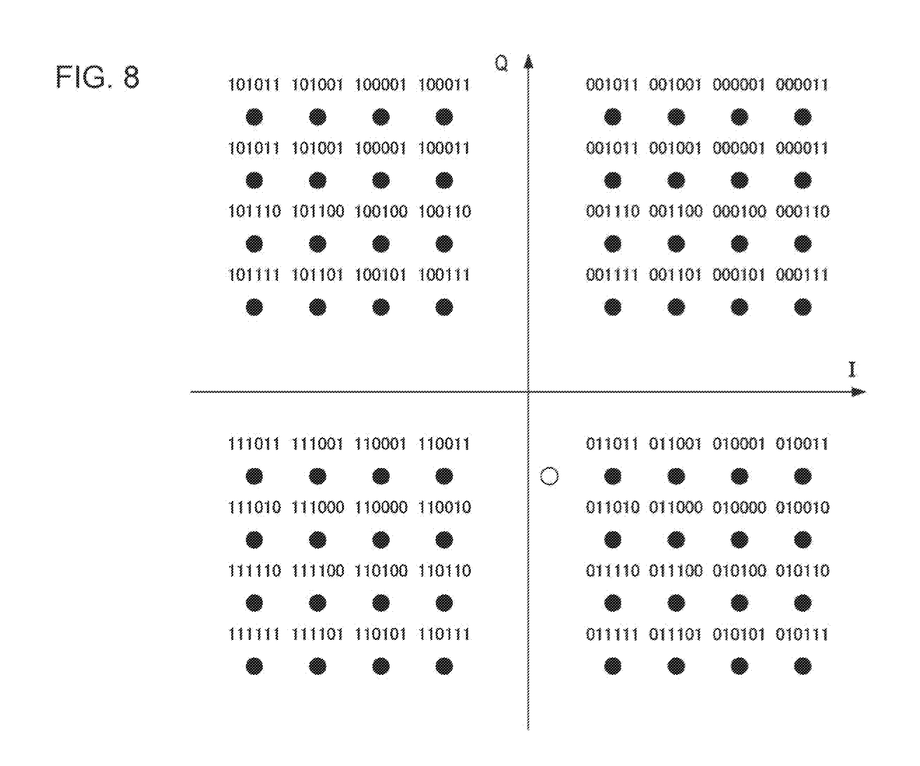

FIG. 8 is a schematic diagram illustrating an example of a relationship between a reception signal point for the terminal apparatus 2A and a signal candidate point of the modulation symbol that is transmitted by the base station apparatus 1A. At this point, in FIG. 8, the base station apparatus 1A modulates (modulation-maps) “110011” that are composite bits, onto a modulation signal point that is labeled as “110011”, and transmits a result of the modulation. Then, a case where the modulation symbol is received in the form of a point indicated by white-blank O due to a noise influence in the terminal apparatus 2A is considered. In this case, the terminal apparatus 2A determines that the closest signal candidate point to the reception signal in FIG. 8 is the modulation symbol that is transmitted by the base station apparatus 1A. That is, the terminal apparatus 2A determines the composite bits that are transmitted by the base station apparatus 1A are “011011”. In this case, the 4-bit information that is actually transmitted by the base station apparatus 1A to the terminal apparatus 2A is “0011”, and on the other hand, the terminal apparatus 2A determines that the 4-bit information that is transmitted by the base station apparatus 1A to a destination that is the terminal apparatus 2A itself is “1011”. That is, the terminal apparatus 2A causes an error to occur in one bit among four bits when performing the reception processing. This is because in the example in the related art, in a case where the base station apparatus 1A labels the composite bits with the modulation signal point, differences occur in two bits among six bits, in neighboring two modulation signal points that are positioned in different quadrants. In the present embodiment, in order to work out the answer to the problem describe, the base station apparatus 1A changes a method of labeling the composite bits to point to the modulation symbol, particularly, a method of labeling to point to the modulation symbol that represents the transmission bit that is addressed to the terminal apparatus 2A.

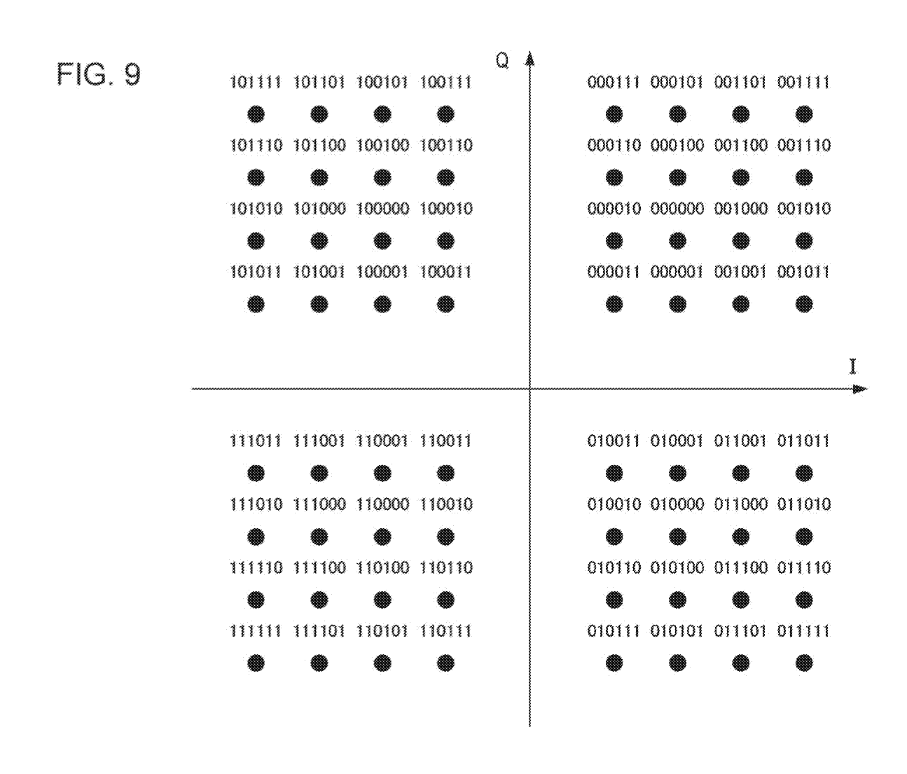

FIG. 9 is a schematic diagram illustrating an example of modulation signal points in a case where the base station apparatus 1A according to the present embodiment non-orthogonally multiplexes PDSCH 1 and PDSCH 2. As illustrated in FIG. 9, the base station apparatus 1A according to the present embodiment changes the method of labeling the transmission bits, which are addressed to the terminal apparatus 2A, to point to the modulation symbol, based on the transmission bits that are addressed to the terminal apparatus 2B. In an example in FIG. 9, in a case where the base station apparatus 1A transmits two-bit information that is “11” to a destination that is the terminal apparatus 2B, the base station apparatus 1A transmits 4-bit information that is addressed to the terminal apparatus 2A, using labeling to point to the modulation signal point in compliance with 16 QAM in the related art. That is, in a case where the transmission bits that are addressed to the terminal apparatus 2A are “0011”, the base station apparatus 1A sets the modulation signal point that is labeled as “110011” in FIG. 9 to be the modulation symbol that represents the composite bits.

Furthermore, in a case where the base station apparatus 1A transmits 2-bit information that is “10” to a destination that is the terminal apparatus 2B, the base station apparatus 1A transmits 4-bit information that is addressed to the terminal apparatus 2A, using the modulation signal point that has a relationship, which is defined as line-symmetry about the Q axis, with the modulation signal point in compliance with 16 QAM in the related art. That is, in the case where the transmission bits that are addressed to the terminal apparatus 2A are “0011”, the base station apparatus 1A sets the modulation signal point that is labeled as “100011” in FIG. 9 to be the modulation symbol that represents the composite bits. Furthermore, in a case where the base station apparatus 1A transmits 2-bit information that is “01” to a destination that is the terminal apparatus 2B, the base station apparatus 1A transmits 4-bit information that is addressed to the terminal apparatus 2A, using the modulation signal point that has a relationship, which is defined as line-symmetry about the Q axis, with the modulation signal point in compliance with 16 QAM in the related art. Furthermore, in a case where the base station apparatus 1A transmits 2-bit information that is “00” to a destination that is the terminal apparatus 2B, the base station apparatus 1A transmits 4-bit information that is addressed to the terminal apparatus 2A, using the modulation signal point, with the modulation signal point and the modulation signal point in compliance with 16 QAM in the related art being point-symmetrical about the origin.

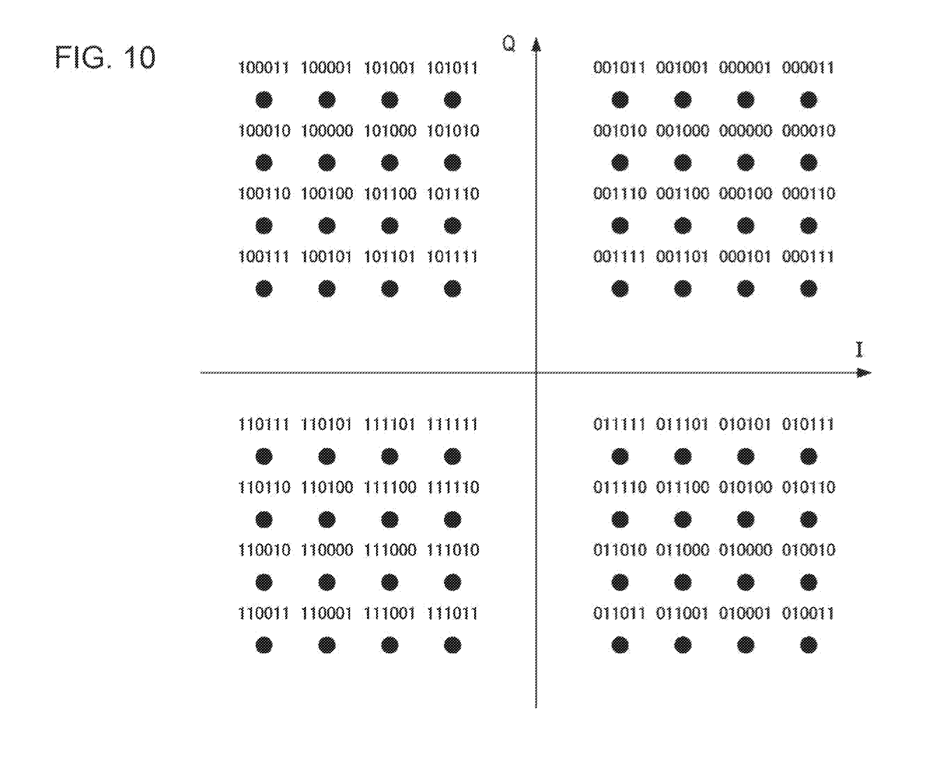

In this manner, the modulation of the composite bits onto the modulation symbol by the base station apparatus 1A makes it possible to set a difference to occur in one bit in all sets of neighboring two modulation signal points. It is noted that a method in which the base station apparatus 1A modulates the composite bits onto the modulation symbol is not limited to the example in FIG. 9. For example, as illustrated in FIG. 10, the composite bits may be modulated onto the modulation symbol.

In this manner, the base station apparatus 1A according to the present embodiment may change the method of labeling the transmission bits that are addressed to the terminal apparatus 2A to point to the modulation symbol, based on the transmission bits that are addressed to the terminal apparatus 2B. In other words, the base station apparatus 1A may change the method of labeling the composite bits to point to the modulation symbol, based on the transmission bits that are addressed to the terminal apparatus 2B. Moreover, in other words, the base station apparatus 1A may change the modulation signal point that complies with the first modulation scheme, based on the transmission bits that are addressed to the terminal apparatus 2B. Moreover, in other words, the base station apparatus 1A may change the modulation signal point that is set to be the modulation symbol that represents the composite bits, based on the transmission bits that are addressed to the terminal apparatus 2B. Moreover, in other words, the base station apparatus 1A determines the labeling method, according to whether or not the transmit signal that is transmitted to the terminal apparatus 2B is non-orthogonally multiplexed onto the transmit signal that is transmitted to the terminal apparatus 2A. Moreover, in other words, the base station apparatus 1A changes the labeling method, and thus determine whether or not the transmit signal that is transmitted to the terminal apparatus 2B is non-orthogonally multiplexed onto the transmit signal that is transmitted to the terminal apparatus 2A.

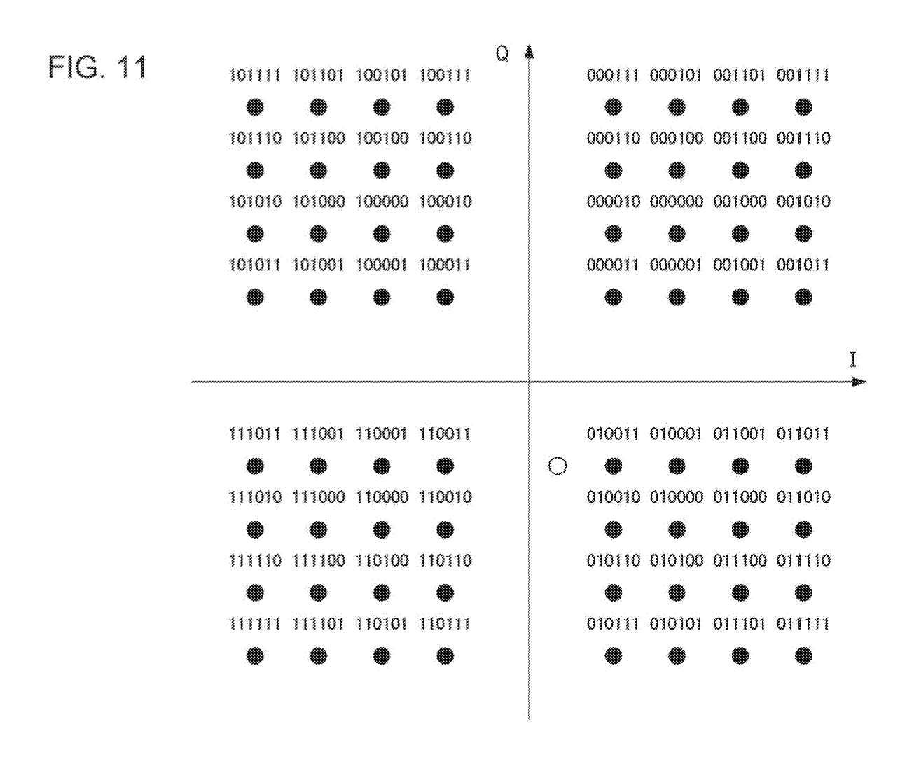

FIG. 11 is a schematic diagram illustrating an example of an aspect of the modulation signal that is received in the terminal apparatus 2A, in a case where PDSCH 1 and PDSCH 2 that result from the non-orthogonal multiplexing by the base station apparatus 1A according to the present embodiment are transmitted. At this point, a case is considered where, in the same manner as illustrated in FIG. 8, while the modulation symbol that is actually transmitted by the base station apparatus 1A is the modulation signal point that is labeled as “110011” in FIG. 11, the signal point that is received by the terminal apparatus 2A is received in the form of a point indicated by white-blank O due to the noise influence in FIG. 11. In this case, the terminal apparatus 2A determines that a signal point that is labeled as “010011” which is the closest signal candidate point to the reception signal in FIG. 11 is a signal that is transmitted by the base station apparatus 1A. However, because the 4 bits that the terminal apparatus 2A demodulates, as information that is addressed to the terminal apparatus 2A itself, from the signal point, are “0011”, the terminal apparatus 2A does not cause an error due to the reception processing. Consequently, the communication system that includes the base station apparatus 1A, the terminal apparatus 2A, and the terminal apparatus 2B according to the present embodiment can realize non-orthogonal multiplexing communication that has higher quality than in the example in the related art.

The base station apparatus 1A may change the method of labeling the composite bits to point to the modulation symbol, based on the RV of PDSCH 1. A case where the base station apparatus 1A receives a retransmission request from the terminal apparatus 2A is considered. At this point, in a case where the RV of PDSCH 1 that is retransmitted by the base station apparatus 1A to the terminal apparatus 2A is the same as the RV of PDSCH 1 that is to be initially transmitted (or is already transmitted), the base station apparatus 1A can use the labeling method that is used to map the composite bits which include PDSCH 1 that is to be initially transmitted, to the modulation symbol, when mapping the composite bits that include the PDSCH 1 which is retransmitted, to the modulation symbol. With this control, it is possible that the base station apparatus 1A non-orthogonally multiplexes the PDSCH (for example, PDSCH 2) to another terminal apparatus, in a suitable manner, onto PDSCH 1 that is to be retransmitted. Furthermore, it is possible that the terminal apparatus 2A performs packet combination (for example, chase combination that is packet combination which is performed at a symbol level) of PDSCH 1 that is to be retransmitted, for which the same RV is configured, and PDSCH 1 that is to be initially transmitted, in a suitable manner.

Furthermore, the base station apparatus 1A notifies the terminal apparatus 2A of the RV, and this makes it possible for the base station apparatus 1A to notify the terminal apparatus 2A of the labeling method that is used when the composite bits that include PDSCH 1 that is to be retransmitted are mapped to the modulation symbol. Thus, it is possible that overhead relating to the notification of the labeling method is suppressed. Otherwise, because it is desirable that the base station apparatus 1A explicitly signals the terminal apparatus 2A of the labeling method that is used for PDSCH 1 which is to be retransmitted (for example, the base station apparatus 1A notifies the terminal apparatus 2A of new control information), overhead is increased.

Furthermore, in a case where, from the terminal apparatus 2A that transmits PDSCH 1 in a state of being non-orthogonally multiplexed, the base station apparatus 1A receives a request for retransmission of PDSCH 1 in question, and retransmits PDSCH 1 for which the same RV as is configured for PDSCH 1 in question is configured, in a state of being orthogonally multiplexed, the base station apparatus 1A can use the labeling method that is used to map the composite bits that include PDSCH 1 which is transmitted in the state of being non-orthogonally multiplexed, to the modulation symbol, to map PDSCH 1 that is retransmitted in the state of being orthogonally multiplexed, to the modulation symbol. With this control, it is possible that the terminal apparatus 2A performs the chase combination of PDSCH 1 that is retransmitted, in the state of being orthogonally multiplexed, to a destination that is the terminal apparatus 2A itself, and PDSCH 1 that is transmitted in the state of being non-orthogonally multiplexed, which have already been received. It is noted that the base station apparatus 1A may not make the RV of PDSCH 1, which is to be initially transmitted, and the RV of PDSCH 1, which is to be retransmitted, consistent with each other. In other words, it is also said that, although there is a difference in the multiplexed state (a change from the non-orthogonal multiplexing to the orthogonal multiplexing) between PDSCH 1 that is to be initially transmitted and PDSCH 1 that is to be retransmitted, the base station apparatus 1A uses the labeling method that is used to modulate PDSCH 1 to be initially transmitted onto the modulation symbol, when modulating PDSCH 1 to be retransmitted onto the modulation symbol. Consequently, in a case where the base station apparatus 1A retransmits PDSCH 1 in question, in the state of being non-orthogonally multiplexed, to the terminal apparatus 2A that receives PDSCH 1 in the state of being orthogonally multiplexed, the base station apparatus 1A can use the labeling method that is used to modulate PDSCH 1 that is to be initially transmitted, which is transmitted in the state of being orthogonally multiplexed, to modulate PDSCH 1 that is to be retransmitted, which is transmitted in the state of being non-orthogonally multiplexed.

Furthermore, in a case where the base station apparatus 1A transmits PDSCH 1 that is to be retransmitted, for which the same RV as is configured for the initially transmitted PDSCH 1 is applied, to the terminal apparatus 2A, the base station apparatus 1A can use the labeling method different from the labeling method that is used for PDSCH 1 that is to be initially transmitted, for PDSCH 1 that is to be retransmitted. For example, in a case where the labeling that is illustrated in FIG. 9 is used for labeling for PDSCH 1 that is to be initially transmitted, the base station apparatus 1A can use labeling that is illustrated in FIG. 10, for PDSCH 1 that is to be retransmitted. Moreover, the base station apparatus 1A may use the labeling method that is not based on the transmission bits which are addressed to the terminal apparatus 2B, as a labeling method for PDSCH 1 that is to be initially transmitted or to be retransmitted.

Furthermore, the base station apparatus 1A applies the same labeling method to PDSCH 1 that is to be initially transmitted and PDSCH 1 that is to be retransmitted. On the other hand, a value of a transmit power for PDSCH 1 that is to be retransmitted may be different from a value of a transmit power for PDSCH 1 that is to be initially transmitted. At this time, when transmitting PDSCH 1 that is to be retransmitted, the base station apparatus 1A can include information relating to the transmit power for PDSCH 1 that is to be retransmitted, in control information that is transmitted on the PDCCH or the like. For example, the base station apparatus 1A may include the value of the transmit power for PDSCH 1 that is to be initially retransmitted, in the control information, and may include a value of a difference between the transmit power for PDSCH 1 that is to be retransmitted and the transmit power for PDSCH 1 that is to be initially transmitted, in the control information.

With regard to a retransmit signal that is transmitted to a destination that is a terminal apparatus which communicates with the base station apparatus 1A itself, the signal detection unit 2043 of the terminal apparatus 2A according to the present embodiment can acquire the labeling method that is used for the base station apparatus 1A to modulate the composite bits that include the transmission bits which are addressed to the terminal apparatus that communicates with the base station apparatus 1A itself, on the modulation symbol, based on the RV that is notified to a destination that is the terminal that communication with the base station apparatus 1A itself. In a case where the RV is configured for PDSCH 1 that is to be retransmitted, which is transmitted to a destination that is the terminal apparatus 2A itself, is the same as the RV that is configured for corresponding PDSCH 1 that is to be initially transmitted, the signal detection unit 2043 can analyze the labeling method that is used by the base station apparatus 1A to modulate the composite bits that include PDSCH 1 which is to be retransmitted, onto the modulation symbol, as the labeling method that is used to modulate the composite bits that include PDSCH 1 which is to be initially transmitted, onto the modulation symbol, and can perform the packet combination of PDSCH 1 that is to be initially transmitted and PDSCH 1 that is to be retransmitted, in a suitable manner. Thus, reception quality can be improved.

Furthermore, the terminal apparatus 2A acquires the RV that is configured for PDSCH 1 that is to be retransmitted, and thus can acquire the labeling method that the base station apparatus 1A applies to PDSCH 1 that is to be retransmitted. Consequently, because the base station apparatus 1A does not have to explicitly signal the terminal apparatus 2A of the labeling method that applies to PDSCH 1 that is to be retransmitted. Thus, the overhead can be suppressed.

Furthermore, the terminal apparatus 2A can know whether PDSCH 1 to the terminal apparatus 2A itself is included by the base station apparatus 1A in the composite bits (that is, is non-orthogonally multiplexed with PDSCH 2 to another terminal apparatus), or is not included in the composite bits (that is, is orthogonally multiplexed with PDSCH 2 to another terminal apparatus), depending on the signaling from the base station apparatus 1A or the blind detection. At this time, in a case where PDSCH 1 that is to be initially transmitted is included in the composite bits, where PDSCH 1 that is to be retransmitted is not included in the composite bits, and where the terminal apparatuses 2A analyzes this to mean that the same RV is configured for each of two PDSCHs 1 in question, the signal detection unit 2043 analyzes this to mean that the same labeling applies to PDSCH 1 that is to be initially transmitted and PDSCH 1 that is to be retransmitted, and thus can perform signal detection processing (for example, chase combination).

### 3. Aspects that are Common to All Embodiments

It is noted that a program running on the base station apparatus and the terminal apparatus according to the present invention is a program (a program for causing a computer to perform functions) that controls a CPU and the like in such a manner as to realize the functions according to the embodiments of the present invention, which are described above. Then, information that is handled in these apparatuses is temporarily accumulated in a RAM while being processed. Thereafter, the information is stored in various ROMs or HDDs, and if need arises, is read by the CPU to be modified or written. Of a semiconductor medium (for example, a ROM, a nonvolatile memory card, or the like), an optical storage medium (for example, a DVD, a MO, a MD, a CD, a BD, or the like), a magnetic recording medium (for example, a magnetic tape, a flexible disk, or the like), and the like, any one may be possible as a recording medium on which to store the program. Furthermore, in some cases, the functions according to the embodiments, which are described above, are realized by executing the loaded program, and in addition, the functions according to the present invention are realized by performing processing in conjunction with an operating system, other application programs, or the like, based on an instruction from the program.

Furthermore, in a case where the programs are distributed on the market, the programs, each of which is stored on a portable recording medium, can be distributed, or can be transferred to a server computer that is connected through a network, such as the Internet. In this case, a storage device of the server computer also falls within the scope of the present invention. Furthermore, some or all of the portions of each of the terminal apparatus and the base station apparatus according to the embodiments, which are described above, may be realized as an LSI that is a typical integrated circuit. Each functional block of a reception apparatus may be individually built into a chip, and one or several of, or all of the functional blocks may be integrated into a chip. In a case where each of the functional blocks is integrated into a circuit, an integrated circuit control unit is added that controls the functional blocks.

Furthermore, a technique for the integrated circuit is not limited to the LSI, and an integrated circuit for the functional block may be realized as a dedicated circuit or a general-purpose processor. Furthermore, if, with advances in semiconductor technology, a circuit integration technology for a circuit with which an LSI is replaced will appear, it is also possible that an integrated circuit to which such a technology applies is used.

It is noted that the invention in the present application is not limited to the embodiments described above. Furthermore, application of the terminal apparatus according to the invention in the present application is not limited to a mobile station apparatus. It goes without saying that the terminal apparatus can be applied to a stationary-type electronic apparatus that is installed indoors or outdoors, or a non-movable-type electronic apparatus, for example, an AV apparatus, a kitchen apparatus, a cleaning or washing machine, an air conditioner, office equipment, a vending machine, and other household apparatuses.

The embodiments of the present invention are described in detail above with reference to the drawings, but specific configurations are not limited to the embodiments. A design and the like within the scope not departing from the gist of the present invention also fall within the scope of the claims.

### INDUSTRIAL APPLICABILITY

The present invention is suitable for use in a base station apparatus, a terminal apparatus, and a communication method.

It is noted that, the present international application claims the benefits of Japanese Patent Application No. 2015-036029 filed on Feb. 26, 2015, and the entire contents of Japanese Patent Application No. 2015-036029 are incorporated herein by reference.

### REFERENCE SIGNS LIST

1A BASE STATION APPARATUS
2, 2A, 2B TERMINAL APPARATUS
101 HIGHER LAYER PROCESSING UNIT
102 CONTROL UNIT
103 TRANSMISSION UNIT
104 RECEPTION UNIT
105 TRANSMIT AND RECEIVE ANTENNA
1011 RADIO RESOURCE CONTROL UNIT
1012 SCHEDULING UNIT
1031 CODING UNIT
1032 MODULATION UNIT
1033 DOWNLINK REFERENCE SIGNAL GENERATING UNIT
1034 MULTIPLEXING UNIT
1035 WIRELESS TRANSMISSION UNIT
1041 WIRELESS RECEPTION UNIT
1042 DEMULTIPLEXING UNIT
1043 DEMODULATION UNIT
1044 DECODING UNIT
201 HIGHER LAYER PROCESSING UNIT
202 CONTROL UNIT
203 TRANSMISSION UNIT
204 RECEPTION UNIT
205 CHANNEL STATE INFORMATION GENERATING UNIT
206 TRANSMIT AND RECEIVE ANTENNA
2011 RADIO RESOURCE CONTROL UNIT
2012 SCHEDULING INFORMATION ANALYSIS UNIT
2031 CODING UNIT
2032 MODULATION UNIT
2033 UPLINK REFERENCE SIGNAL GENERATING UNIT
2034 MULTIPLEXING UNIT
2035 WIRELESS TRANSMISSION UNIT
2041 WIRELESS RECEPTION UNIT
2042 DEMULTIPLEXING UNIT
2043 SIGNAL DETECTION UNIT
301 TURBO CODING UNIT
302-1, 302-2, 302-3, INTERLEAVING UNIT
303 BIT SELECTION UNIT

1-20. (canceled)

21. A terminal apparatus that communicates with a base station apparatus, the terminal apparatus comprising:
a reception unit provided with
a function of receiving information indicating a labeling method used for a transmit signal that is transmitted from the base station apparatus to the terminal apparatus itself and information relating to a retransmission state of the transmit signal that is transmitted to the terminal apparatus itself; and
a function of receiving a non-orthogonal multiplexing signal that results from the base station apparatus non-orthogonally multiplexing at least some of the transmit signal that is transmitted to the terminal apparatus itself and a transmit signal that is transmitted to another terminal apparatus, for transmission, using the same radio resource; and
a demodulation unit that performs demodulation processing based on the information indicating the labeling method and the information relating to the retransmission state.

22. The terminal apparatus according to claim 21, wherein
the demodulation unit switches between performing and not performing interference suppression on the non-orthogonal multiplexing signal, based on the information relating to the retransmission state, in a case where the information indicating the labeling method indicates a predetermined labeling method.

23. The terminal apparatus according to claim 22, wherein
the information indicating the labeling method is a transmission mode, and
the demodulation unit performs demodulation processing based on the information relating to the retransmission state, in a case where the transmission mode is a predetermined transmission mode.

24. The terminal apparatus according to claim 23, wherein
the predetermined transmission mode is a transmission mode capable of receiving the non-orthogonal multiplexing signal.

25. The terminal apparatus according to claim 24, wherein
the demodulation unit performs interference suppression on the non-orthogonal multiplexing signal, only when the transmission mode indicates the transmission mode capable of receiving the non-orthogonal multiplexing signal and the information relating to the retransmission state indicates that the transmit signal transmitted to the terminal apparatus itself is an initial signal.

26. The terminal apparatus according to claim 22, wherein
the information relating to the retransmission state is a new data indicator (NDI), and
the demodulation unit performs the demodulation processing on the transmit signal that is transmitted to the terminal apparatus itself, regarding the transmit signal that is transmitted to the other terminal apparatus as not being non-orthogonally multiplexed by the base station apparatus, in a case where the NDI indicates that the transmit signal transmitted to the terminal apparatus itself is a retransmit signal.

27. The terminal apparatus according to claim 22, wherein
the information relating to the retransmission state is a redundancy version (RV), and
the demodulation unit performs the demodulation processing on the transmit signal that is transmitted to the terminal apparatus itself, regarding the transmit signal that is transmitted to the other terminal apparatus as not being non-orthogonally multiplexed by the base station apparatus, in a case where the RV is a value other than a value indicating that the largest number of systematic bits are included in the transmit signal.

28. A base station apparatus that communicates with a plurality of terminal apparatuses, the base station apparatus comprising:
a modulation unit provided with a function of generating, based on information indicating a labeling method used for a transmit signal that is transmitted to the plurality of terminal apparatuses, a non-orthogonal multiplexing signal resulting from non-orthogonally multiplexing at least some of transmit signals that are transmitted to the plurality of terminal apparatuses, using the same radio resource; and
a transmission unit that transmits to the plurality of terminal apparatuses the information indicating the labeling method and information relating to a retransmission state of the transmit signals that are transmitted to the plurality of terminal apparatuses.

29. The base station apparatus according to claim 28, wherein
the modulation unit switches between performing and not performing the non-orthogonal multiplexing on the transmit signals that are transmitted to the plurality of terminal apparatuses, based on the information relating to the retransmission state, in a case where the information indicating the labeling method indicates a predetermined labeling method.

30. The base station apparatus according to claim 29, wherein
the information indicating the labeling method is a transmission mode, and
the modulation unit switches between performing and not performing the non-orthogonal multiplexing on the transmit signals that are transmitted to the plurality of terminal apparatuses, based on the information relating to the retransmission state, in a case where the transmission mode is a predetermined transmission mode.

31. The base station apparatus according to claim 30, wherein
the predetermined transmission mode is a transmission mode capable of transmitting the non-orthogonal multiplexing signal.

32. The base station apparatus according to claim 29, wherein
the information relating to the retransmission state is a new data indicator (NDI), and
the modulation unit does not perform the non-orthogonal multiplexing on the transmit signals that are transmitted to the plurality of terminal apparatuses, in a case where the NDI that is configured for at least one of the transmit signals that are transmitted to the plurality of terminal apparatuses is a value indicating that the transmit signal is a retransmit signal.

33. The base station apparatus according to claim 29, wherein
the information relating to the retransmission state is a redundancy version (RV), and
the modulation unit does not perform the non-orthogonal multiplexing on the transmit signals that are transmitted to the plurality of terminal apparatuses, in a case where the RV that is configured for at least one of the transmit signals that are transmitted to the plurality of terminal apparatuses is a value other than a value indicating that the largest number of systematic bits are included.

34. A communication method for use in a terminal apparatus that communicates with a base station apparatus, the method comprising:
a step of receiving information indicating a labeling method used for a transmit signal that is transmitted from the base station apparatus to the terminal apparatus itself and information relating to a retransmission state of the transmit signal that is transmitted to the terminal apparatus itself;
a step of receiving a non-orthogonal multiplexing signal that results from the base station apparatus non-orthogonally multiplexing at least some of the transmit signal that is transmitted to the terminal apparatus itself and a transmit signal that is transmitted to another terminal apparatus, for transmission, using the same radio resource; and
a step of performing demodulation processing based on the information indicating the labeling method and the information relating to the retransmission state.
